(19) United States
(12) Patent Application Publication
(10) Pub. No.: US 2012/0271534 A1
(43) Pub. Date: Oct. 25, 2012

(54) CONTROL DEVICE FOR INTERNAL COMBUSTION ENGINE

(75) Inventors: Masahiro KACHI, Susono-shi (JP); Shinya KONDO, Gotemba-shi (JP); Yasuyuki TAKAMA, Gotemba-shi (JP)

(73) Assignee: TOYOTA JIDOSHA KABUSHIKI KAISHA, Toyota-shi (JP)

(21) Appl. No.: 13/450,850

(22) Filed: Apr. 19, 2012

(30) Foreign Application Priority Data
Apr. 20, 2011 (JP) 2011-094007

(51) Int. Cl. F02D 41/26

(52) U.S. Cl. 701/108

(57) ABSTRACT

A control device for an internal combustion engine with a catalyst includes: an air-fuel ratio control unit varying a fuel amount supplied to the engine in accordance with a first variation amount set such that an air-fuel ratio of air-fuel mixture coincides with a target ratio; and an exhaust gas temperature control unit varying a fuel amount supplied to the engine in accordance with a second variation amount set to decrease an exhaust gas temperature. When air-fuel ratio control is being executed at a first time point and at least exhaust gas temperature control is executed during a period from the first time point or later to a third time point thereafter, the first and second variation amounts at a fourth time point in the period are set so as to be larger than or equal to the first variation amount at the first time point.

### INCORPORATION BY REFERENCE

The disclosure of Japanese Patent Application No. 2011-094007 filed on Apr. 20, 2011 including the specification, drawings and abstract is incorporated herein by reference in its entirety.

### BACKGROUND OF THE INVENTION

1. Field of the Invention

The invention relates to a control device that is applied to an internal combustion engine equipped with a catalyst.

2. Description of Related Art

Gas (exhaust gas) emitted from a combustion chamber of an internal combustion engine contains various substances. Then, in an existing art, there has been suggested an internal combustion engine equipped with a catalyst that removes those substances from exhaust gas to purify the exhaust gas. Such a catalyst is, for example, a so-called three-way catalyst, a NOx storage reduction catalyst, or the like. As is generally known, these catalysts each are able to purify exhaust gas at a high catalytic conversion efficiency when the temperature of the catalyst is higher than or equal to a specific activating temperature and the oxygen concentration of exhaust gas is close to a specific oxygen concentration (the oxygen concentration of exhaust gas that arises when air-fuel mixture obtained by mixing air and fuel at a stoichiometric air-fuel ratio combusts, and, hereinafter, for the sake of convenience, also referred to as “reference oxygen concentration”). Hereinafter, for the sake of convenience, a three-way catalyst, a NOx storage reduction catalyst, or the like, is simply collectively referred to as “catalyst”.

As described above, in order for exhaust gas to be purified at a high catalytic conversion efficiency, the temperature of the catalyst needs to be higher than or equal to an activating temperature. The temperature of the catalyst, for example, increases as the catalyst is heated by exhaust gas. However, as the temperature of the catalyst excessively increases, the exhaust gas conversion performance of the catalyst may degrade because of, for example, thermal denaturation, or the like, of substances (for example, noble metal, oxygen storage substance, carrier, and the like) that constitute the catalyst. Then, one of existing control devices for an internal combustion engine (hereinafter, also referred to as “existing device”) is configured to focus on the correlation between the temperature of the catalyst and the temperature of exhaust gas and control the temperature of the catalyst by adjusting the amount of fuel contained in air-fuel mixture (in other words, the amount of fuel supplied to the internal combustion engine).

Specifically, the existing device estimates the temperature of the catalyst on the basis of the operating state of the internal combustion engine. Then, when the estimated temperature of the catalyst is higher than or equal to a predetermined upper limit temperature, the existing device increases the amount of fuel supplied to the internal combustion engine as compared with the amount of fuel supplied in the case where the temperature of the catalyst is not higher than or equal to the upper limit temperature. By so doing, the amount of energy consumed at the time when fuel vaporizes is increased, so the amount of energy emitted into exhaust gas is reduced. As a result, the temperature of exhaust gas is lower than the temperature of exhaust gas in the case where the amount of fuel is not increased, so it is possible to prevent an excessive increase in the temperature of the catalyst. Hereinafter, the fact that the temperature of exhaust gas is decreased by increasing the amount of fuel is also referred to as “fuel cooling effect”.

As described above, in the internal combustion engine equipped with the catalyst, the amount of fuel supplied to the engine is increased to thereby decrease the temperature of exhaust gas. Then, the temperature of exhaust gas is decreased to thereby make it possible to prevent an excessive increase in the temperature of the catalyst. Hereinafter, for the sake of convenience, control for decreasing the temperature of exhaust gas by adjusting the amount of fuel is also referred to as “exhaust gas temperature control”.

Incidentally, as described above, in order for exhaust gas to be purified at a high catalytic conversion efficiency, the oxygen concentration of exhaust gas is required to be a specific oxygen concentration (oxygen concentration close to the reference oxygen concentration). The oxygen concentration of exhaust gas varies in association with, for example, the air-fuel ratio of air-fuel mixture. Then, in the internal combustion engine equipped with the catalyst, for example, the amount of fuel contained in air-fuel mixture is adjusted such that the oxygen concentration of exhaust gas coincides with the oxygen concentration close to the reference oxygen concentration. Then, the oxygen concentration of exhaust gas is controlled to thereby make it possible to maintain the state where exhaust gas is purified at a high catalytic conversion efficiency. Hereinafter, for the sake of convenience, controlling the air-fuel ratio of air-fuel mixture by adjusting the amount of fuel is also referred to as “air-fuel ratio control”.

In this way, in the internal combustion engine equipped with the catalyst, the amount of fuel may be varied by both exhaust gas temperature control and air-fuel ratio control. To put it the other way around, the amount of fuel can influence both exhaust gas temperature control and air-fuel ratio control. Therefore, it is presumable that, when exhaust gas temperature control and air-fuel ratio control are executed independently without sufficient consideration of the correlation between these controls, the purpose of one or both of these controls may not be sufficiently achieved.

### SUMMARY OF THE INVENTION

The invention provides a control device for an internal combustion engine, which is able to appropriately execute exhaust gas temperature control and air-fuel ratio control as much as possible.

The control device according to an aspect of the invention is applied to an internal combustion engine equipped with a catalyst that purifies gas (exhaust gas) emitted from a combustion chamber of the internal combustion engine.

The catalyst just needs to be able to purify exhaust gas and is not specifically limited. The catalyst may be, for example, a known three-way catalyst that has a noble metal as a catalyst component and a carrier that contains an oxygen storage substance. Furthermore, the catalyst may be, for example, a known NOx storage reduction catalyst that has a noble metal as a catalyst component and a carrier that contains an oxygen storage substance and a NOx storage substance.

Note that the phrase “purifies exhaust gas” means to remove at least part of purification target substances, such as nitrogen oxides and unburned substances that are contained in exhaust gas, from the exhaust gas, and does not necessarily mean to remove the entire purification target substances from the exhaust gas.

An aspect of the invention provides a control device that is applied to an internal combustion engine equipped with a catalyst. The control device includes an air-fuel ratio control unit and an exhaust gas temperature control unit. Then, the air-fuel ratio control unit executes control over the air-fuel ratio of air-fuel mixture supplied to the internal combustion engine. The air-fuel ratio control unit varies an amount of fuel supplied to the internal combustion engine in accordance with a “first variation amount that is set so as to bring the air-fuel ratio into coincidence with a target air-fuel ratio”.

As is known, the air-fuel mixture is gas that contains air and fuel. As is known, the air-fuel ratio is the ratio (A/F) of the amount of air (A) contained in air-fuel mixture to the amount of fuel (F) contained in the air-fuel mixture. Thus, when the amount of air is constant (fixed value), the air-fuel ratio reduces as the amount of fuel increases; whereas the air-fuel ratio increases as the amount of fuel reduces.

The target air-fuel ratio just needs to be set at an adequate value in consideration of the catalytic conversion efficiency of exhaust gas by the catalyst, or the like, and is not specifically limited. For example, the target air-fuel ratio may be a stoichiometric air-fuel ratio or a value that is slightly smaller than the stoichiometric air-fuel ratio. Note that, as is known, the stoichiometric air-fuel ratio represents an air-fuel ratio (about 14.7 in mass ratio) at which, when air-fuel mixture burns, air and fuel react with each other in just proportion.

Hereinafter, an air-fuel ratio smaller than the stoichiometric air-fuel ratio is also referred to as a “rich air-fuel ratio”, and an air-fuel ratio larger than the stoichiometric air-fuel ratio is also referred to as a “lean air-fuel ratio”. That is, the amount of fuel contained in the unit amount of air-fuel mixture having a “rich air-fuel ratio” is larger than the amount of fuel contained in the unit amount of air-fuel mixture having the stoichiometric air-fuel ratio. On the other hand, the amount of fuel contained in the unit amount of air-fuel mixture having a “lean air-fuel ratio” is smaller than the amount of fuel contained in the unit amount of air-fuel mixture having the stoichiometric air-fuel ratio.

The first variation amount just needs to be a “variation amount in the amount of fuel” that is set so as to bring the air-fuel ratio into coincidence with the target air-fuel ratio, and is not specifically limited. The first variation amount may be a positive value, a negative value or zero. For example, when the first variation amount is set in accordance with the concept of feedback control, the first variation amount may be a feedback amount set on the basis of the difference between an actual oxygen concentration of exhaust gas and a reference oxygen concentration.

In addition, the exhaust gas temperature control unit executes control over the temperature of the exhaust gas. The exhaust gas temperature control unit varies the amount of fuel supplied to the internal combustion engine in accordance with a “second variation amount that is set so as to decrease the temperature of the exhaust gas”.

The second variation amount just needs to be a “variation amount in the amount of fuel” that is set so as to decrease the temperature of the exhaust gas, and is not specifically limited. As described above, as the amount of fuel is increased, the temperature of exhaust gas may be decreased owing to the fuel cooling effect. Thus, the second variation amount may be a positive value or zero. For example, the second variation amount may be a variation amount that is set on the basis of the operating state of the internal combustion engine, for example, when the temperature of the catalyst may excessively increase.

As described above, in the control device according to the aspect of the invention, “both” the air-fuel ratio control unit and the exhaust gas temperature control unit vary the amount of fuel supplied to the internal combustion engine. Therefore, it is presumable that, when the first variation amount and the second variation amount are set without taking the correlation between these control units into consideration, one or both of control over the air-fuel ratio of air-fuel mixture and control over the temperature of exhaust gas may not be appropriately executed.

Then, in the control device according to the aspect of the invention, the first variation amount and the second variation amount are set in consideration of the correlation between the air-fuel ratio control unit and the exhaust gas temperature control unit. Specifically, when (A-1) control over the air-fuel ratio is being executed at a “first time point” and (A-2) at least control over the temperature of the exhaust gas between control over the air-fuel ratio and control over the temperature of the exhaust gas is executed during a “catalyst temperature control period that is a period from the first time point or a second time point after the first time point to a third time point after the second time point”, (B) the first variation amount and the second variation amount at a “fourth time point in the catalyst temperature control period” are set such that the total of the first variation amount and the second variation amount at the “fourth time point” is larger than or equal to the first variation amount at the “first time point”.

Hereinafter, the reason why the first variation amount and the second variation amount are set as described above in the control device according to the aspect of the invention will be described. Note that as is understood from the above (A-1), (A-2) and (B), the first time point to the fourth time point are arranged in order of the first time point, the second time point, the fourth time point and the third time point in time sequence.

Initially, when control over the air-fuel ratio is being executed (the above (A-1)), the amount of fuel is adjusted so as to bring the air-fuel ratio of air-fuel mixture into coincidence with the target air-fuel ratio (that is, in accordance with the first variation amount). Subsequently, as control over the temperature of the exhaust gas is started at a time point (the first time point or the second time point) (the above (A-2)), the amount of fuel is adjusted so as to decrease the temperature of the exhaust gas (that is, in accordance with the second variation amount). During the period when control over the temperature of the exhaust gas is executed, control over the air-fuel ratio may be “stopped” or may be “continued”. Note that the period during which “at least control over the temperature of the exhaust gas” between control over the air-fuel ratio and control over the temperature of the exhaust gas is executed is also referred to as a catalyst temperature control period (the above (A-2)).

For example, as control over the air-fuel ratio is “stopped” in the period during which control over the temperature of the exhaust gas is executed (catalyst temperature control period), the “first variation amount” at a time point during the period (fourth time point) is “zero”. Here, when the “second variation amount” at that time point (fourth time point) is “smaller” than a variation amount in the amount of fuel (first variation amount in control over the air-fuel ratio) at or before a time point at which control over the temperature of the exhaust gas is started (that is, a time point at or before the control is started, and, in other words, first time point), the amount of fuel after control over the temperature of the exhaust gas is started is “smaller” than the amount of fuel at or before the control, is started. In other words, in this case, as control over the temperature of the exhaust gas is started, the amount of fuel “reduces”. As a result, in this case, there is a possibility that the fuel cooling effect cannot be appropriately obtained and the temperature of the exhaust gas is not appropriately decreased.

On the other hand, for example, as control over the air-fuel ratio is “continued” during the catalyst temperature control period, the “first variation amount” at the fourth time point is a “positive value, negative value or zero”. Here, when the “total of the first variation amount and the second variation amount” at the fourth time point is “smaller” than the first variation amount at the first time point, the amount of fuel after control over the temperature of the exhaust gas is started is “smaller” than the amount of fuel at or before the control is started as in the case of the above. As a result, in this case as well, the temperature of the exhaust gas may not be appropriately decreased.

In this way, both in the case where control over the air-fuel ratio is stopped in the catalyst temperature control period and in the case where control over the air-fuel ratio is continued, control over the temperature of the exhaust gas may not be appropriately executed. Then, in the control device according to the aspect of the invention, the first variation amount and the second variation amount at a fourth time point in the catalyst temperature control period are set such that “the total of the first variation amount and the second variation amount at the fourth time point is larger than or equal to the first variation amount at the first time point”.

By so doing, the total of the first variation amount and the second variation amount at a selected time point in the catalyst temperature control period (fourth time point) is definitely “larger than or equal to” the first variation amount before the catalyst temperature control period (first time point). In other words, the amount of fuel during the catalyst temperature control period is definitely “larger than” the amount of fuel before the catalyst temperature control period. Thus, the fuel cooling effect may be appropriately obtained during the catalyst temperature control period, so the temperature of the exhaust gas is appropriately decreased during the period. Thus, an excessive increase in the temperature of the catalyst is prevented. Thus, the control device according to the aspect of the invention is able to appropriately achieve the purpose of control over the temperature of the exhaust gas and the purpose of control over the air-fuel ratio (among others, the purpose of control over the temperature of the exhaust gas) in comparison with the case where control is not executed by the control device according to the aspect of the invention.

In addition, in the control device, the catalyst temperature control period may be a period during which it is determined during the catalyst temperature control period that at least one of a “current temperature of the catalyst, which is a temperature of the catalyst at a present time point”, and a “convergence temperature of the catalyst, which is an estimated temperature that the temperature of the catalyst reaches at a future time point”, is higher than or equal to a threshold temperature.

The current temperature of the catalyst may be an actual temperature at the present time point or may be an estimated temperature at the present time point. For example, the actual temperature of the catalyst may be a temperature acquired by a temperature sensor, or the like. On the other hand, for example, the estimated temperature of the catalyst may be a temperature estimated on the basis of the operating state of the internal combustion engine, a temperature estimated on the basis of the temperature of the exhaust gas, a temperature estimated on the basis of the convergence temperature of the catalyst, or the like.

The convergence temperature of the catalyst may be a temperature higher than the current temperature of the catalyst or may be a temperature lower than the current temperature of the catalyst. Note that, of course, the convergence temperature may coincide with the current temperature. The convergence temperature of the catalyst may be, for example, a temperature estimated on the basis of the operating state of the internal combustion engine, a temperature estimated on the basis of the temperature of the exhaust gas, or the like.

The threshold temperature may be an adequate value that is set in consideration of the heat resistance of the catalyst, or the like. For example, the threshold temperature may be a temperature at which it may be determined that the exhaust gas conversion performance of the catalyst may degrade when at least one of the current temperature of the catalyst and the convergence temperature of the catalyst is higher than or equal to the threshold temperature, or the like.

As described above, during the catalyst temperature control period, control over the temperature of the exhaust gas is executed. The control over the temperature of the exhaust gas is desirably executed when it is determined that the temperature of the catalyst may excessively increase. Then, in this aspect, the catalyst temperature control period may be a period during which it is determined during the period that “at least one of the current temperature of the catalyst and the convergence temperature of the catalyst” is higher than or equal to a predetermined threshold temperature. By so doing, the control device according to the aspect of the invention is able to further reliably prevent an excessive increase in the temperature of the catalyst.

Furthermore, in a control device according to another aspect of the invention, the first variation amount may be a variation amount with reference to a “basic amount” that is the amount of fuel set on the basis of the target air-fuel ratio. In addition, the second variation amount may be a variation amount with reference to the basic amount.

The basic amount may be, for example, the amount of fuel calculated on the basis of the amount of air introduced into the internal combustion engine on the basis of the operating state of the internal combustion engine, or the like, and the target air-fuel ratio.

Incidentally, in the control device according to the aspect of the invention, the first variation amount and the second variation amount are set such that “the total of the first variation amount and the second variation amount at a selected time point in the catalyst temperature control period (fourth time point) is definitely larger than or equal to the first variation amount before the catalyst temperature control period (first time point)”. Hereinafter, before the description of the control device according to the aspect of the invention is continued, some examples of a method of setting the first variation amount and the second variation amount will be described.

In a first example, when the second variation amount that is set at the fourth time point is “smaller” than the first variation amount at the first time point, “both” control over the air-fuel ratio and control over the temperature of the exhaust gas may be executed at the fourth time point.

In this example, in the above case, at the fourth time point (selected time point in the catalyst temperature control period), “both” control over the air-fuel ratio and control over the temperature of the exhaust gas are executed. In other words, control over the air-fuel ratio is “continued” during the catalyst temperature control period. As a result, the variation amount at the fourth time point is the total of a variation amount in control over the air-fuel ratio (first variation amount) and a variation amount in control over the temperature of the exhaust gas (second variation amount). Here, it is presumable that the first variation amount at the fourth time point is substantially the same as the first variation amount at the first time point unless the basic amount varies. Thus, at least at a time point at which the basic amount remains unchanged, the total of the first variation amount and the second variation amount is larger than or equal to the first variation amount at the first time point. By so doing, it is possible to prevent an excessive increase in the temperature of the catalyst.

Incidentally, in the above described first example, an “air-fuel ratio smaller than the target air-fuel ratio at the first time point” may be employed as the target air-fuel ratio at the fourth time point.

As the amount of fuel is “increased” by control over the temperature of the exhaust gas (in order to obtain the fuel cooling effect), the air-fuel ratio of air-fuel mixture varies so as to deviate from the target air-fuel ratio toward a rich air-fuel ratio (in other words, so as to reduce the air-fuel ratio). On the other hand, as described above, the air-fuel ratio control unit varies the amount of fuel so as to bring the air-fuel ratio of air-fuel mixture into coincidence with the target air-fuel ratio. Therefore, when the amount of fuel is “increased” as described above, it is presumable that, as control over the air-fuel ratio is executed, the amount of fuel is “reduced” such that the air-fuel ratio of air-fuel mixture approaches the target air-fuel ratio. In other words, a variation amount (increasing amount) due to control over the temperature of the exhaust gas is cut off (hereinafter, also referred to as “eroded”) by a variation amount (reducing amount) due to control over the air-fuel ratio. As a result, it is presumable that the amount of fuel may not be increased to an extent such that the temperature of the exhaust gas is appropriately decreased.

Then, in the above first example, a “value that is smaller than the target air-fuel ratio before control over the temperature of the exhaust gas is started (first time point)” may be employed as the target air-fuel ratio at the fourth time point. By so doing, in comparison with the case where the target air-fuel ratio at the fourth time point is the same as the target air-fuel ratio at the first time point, the temperature of the exhaust gas may be further appropriately decreased.

Furthermore, in the above described first example, the target air-fuel ratio at the fourth time point may be an “air-fuel ratio (AF/C) obtained by dividing the target air-fuel ratio (AF) at the first time point by a value (C) obtained by dividing the sum of the second variation amount at the fourth time point and the basic amount by the basic amount”.

The “value (C) obtained by dividing the sum of the second variation amount at the fourth time point and the basic amount” may be translated into a “value obtained by converting the second variation amount into a variation rate with respect to the basic amount”. For example, when the second variation amount corresponds to a predetermined rate of the basic amount (for example, 5% of the basic amount), the “value (C) obtained by dividing” is a value corresponding to that rate (for example, 1.05). Therefore, the “air-fuel ratio (AF/C) obtained by dividing the target air-fuel ratio (AF) at the first time point by the value (C)” is a value (AF/1.05) that is smaller than the target air-fuel ratio (AF) at the first time point. In this way, the target air-fuel ratio (AF/C) at the fourth time point reduces as the second variation amount increases.

More specifically, when the mass of air (GA) contained in air-fuel mixture at the first time point is the same as that at the fourth time point, the basic amount (1.05×GA/AF) corresponding to the target air-fuel ratio (AF/1.05) obtained by dividing is equal to a value obtained by multiplying the basic amount (GA/AF) corresponding to the original target air-fuel ratio (AF) by the “value (1.05) corresponding to the rate”. Thus, according to this example, when the second variation amount corresponds to a predetermined rate (5%) of the basic amount, the basic amount is varied by that rate (5%) (multiplied by 1.05).

As a result, as the amount of fuel is increased (increased by 5%) by control over the temperature of the exhaust gas (in order to obtain the fuel cooling effect), the basic amount is also increased (multiplied by 1.05) on the basis of the second variation amount. Thus, even when control over the air-fuel ratio is executed in parallel with control over the temperature of the exhaust gas, a “variation amount (increasing amount) due to the second variation amount” is not eroded by control over the air-fuel ratio, so the amount of fuel is reliably increased by the second variation amount. By so doing, the temperature of the exhaust gas may be further appropriately decreased.

Note that the above symbols “C” and “AF” and numeric values “5%” and “1.05” are just intended to be used in order for the aspect of the invention to be easily understood by them, and are not intended to be used for the details of the aspect of the invention to be interpreted restrictively by them.

Subsequently, in a second example, when the second variation amount that is set at the fourth time point is smaller than the first variation amount at the first time point, the second variation amount may be “corrected” to an amount larger than or equal to the first variation amount and then “only control over the temperature of the exhaust gas” between control over the air-fuel ratio and control over the temperature of the exhaust gas may be executed at the fourth time point.

In this example, at the fourth time point (a selected time point in the catalyst temperature control period), “only control over the temperature of the exhaust gas” between control over the air-fuel ratio and control over the temperature of the exhaust gas is executed. In other words, control over the air-fuel ratio is “stopped” during the catalyst temperature control period. However, in this example, the second variation amount at the fourth time point is corrected to a “value larger than or equal to the first variation amount at the first time point”. As a result, the total of the first variation amount and the second variation amount at the fourth time point (actually, only the second variation amount) is definitely larger than or equal to the first variation amount at the first time point. Furthermore, because control over the air-fuel ratio is not executed at the fourth time point, the second variation amount is not eroded by control over the air-fuel ratio. By so doing, the temperature of the exhaust gas may be further appropriately decreased.

Subsequently, in a third example, when the second variation amount set at the fourth time point is smaller than the first variation amount at the first time point, the second variation amount may be corrected to the “sum of the second variation amount and the first variation amount” and then “only control over the temperature of the exhaust gas” between control over the air-fuel ratio and control over the temperature of the exhaust gas may be executed at the fourth time point.

In this example as well, at the fourth time point, “only control over the temperature of exhaust gas” between control over the air-fuel ratio and control over the temperature of the exhaust gas is executed. However, in this example, the second variation amount at the fourth time point is corrected to the “sum of the first variation amount and the second variation amount at the first time point”. As a result, the total of the first variation amount and the second variation amount at the fourth time point (actually, only the second variation amount) is larger than or equal to the first variation amount at the first time point. Furthermore, as in the case of the above, because control over the air-fuel ratio is not executed at the fourth time point, the second variation amount is not eroded by control over the air-fuel ratio. By so doing, the temperature of the exhaust gas may be further appropriately decreased.

Furthermore, in a fourth example, the second variation amount may be a “corrected variation amount” obtained by multiplying a “reference variation amount, which is set on the basis of an operating state of the internal combustion engine and which is larger than the first variation amount at the first time point”, by a “correction coefficient that approaches 1 as the current temperature of the catalyst approaches the convergence temperature of the catalyst”.

As described above, the second variation amount may be a variation amount in the amount of fuel, which is set so as to decrease the temperature of exhaust gas. In this example, a “reference variation amount” is set on the basis of an operating state of the internal combustion engine, and the reference variation amount is corrected in consideration of the temperature of the catalyst. By so doing, the second variation amount at the fourth time point may be set as an appropriate amount corresponding to not only the operating state of the internal combustion engine but also the temperature of the catalyst.

A method of setting the correction coefficient is not specifically limited. For example, in the above fourth example, the correction coefficient may be a value ((P−T)/(F−T)) obtained by dividing a “difference between the current temperature (P) of the catalyst and the threshold temperature (T)” by a “difference between the convergence temperature (F) of the catalyst and the threshold temperature (T)”.

Some of examples of a method of setting the first variation amount and the second variation amount in the control device according to the aspect of the invention are described above.

Furthermore, the target air-fuel ratio at the first time point may be a “stoichiometric air-fuel ratio”.

As described above, when the oxygen concentration of the exhaust gas is an oxygen concentration close to the reference oxygen concentration, the catalyst is able to purify the exhaust gas at a high catalytic conversion efficiency. Then, in this aspect, the target air-fuel ratio at the first time point (that is, a time point before control over the temperature of the exhaust gas is started, and a time point at which control over the air-fuel ratio is being executed) may be a stoichiometric air-fuel ratio. By so doing, the control device according to the aspect of the invention is able to purify the exhaust gas at a high catalytic conversion efficiency at the first time point.

Incidentally, in the control device according to the aspect of the invention, including the above described several modes, the catalyst may have such a characteristic that a catalytic conversion efficiency of “nitrogen oxides” contained in the exhaust gas by the catalyst decreases at a first decreasing rate in the case where the oxygen concentration of the exhaust gas deviates from a reference oxygen concentration, which is the oxygen concentration of the exhaust gas that arises when the air-fuel ratio of the air-fuel mixture is the stoichiometric air-fuel ratio, in a “direction in which the oxygen concentration increases” and the catalytic conversion efficiency of the nitrogen oxides decreases at a second decreasing rate smaller than the first decreasing rate in the case where the oxygen concentration of the exhaust gas deviates from the reference oxygen concentration in a “direction in which the oxygen concentration reduces”.

As described above, the catalyst removes various substances, contained in the exhaust gas, from the exhaust gas to purify the exhaust gas. It is presumable that the catalytic conversion efficiencies of these substances in the exhaust gas generally vary in association with the types of these substances and vary in association with the oxygen concentration of the exhaust gas as well.

Then, among others, in terms of efficiently purifying nitrogen oxides (NOx) contained in the exhaust gas, the catalyst equipped for the control device according to the aspect of the invention may be a catalyst having the above characteristic. The catalyst has such a characteristic that “the decreasing rate (second decreasing rate) of the catalytic conversion efficiency at the time when the oxygen concentration of the exhaust gas deviates from the reference oxygen concentration in a direction in which the oxygen concentration reduces is smaller than the decreasing rate (first decreasing rate) at the time when the oxygen concentration of the exhaust gas deviates from the reference oxygen concentration in a direction in which the oxygen concentration increases”.

Note that the direction in which the oxygen concentration of the exhaust gas reduces corresponds to the direction in which the air-fuel ratio reduces (becomes richer). In addition, the direction in which the oxygen concentration of the exhaust gas increases corresponds to the direction in which the air-fuel ratio increases (becomes leaner).

As described above, the control device according to the aspect of the invention sets the first variation amount and the second variation amount such that the amount of fuel during the catalyst temperature control period is larger than the amount of fuel before the catalyst temperature control period (that is, the oxygen concentration of the exhaust gas reduces, and the air-fuel ratio becomes richer). Therefore, for example, when the target air-fuel ratio of air-fuel mixture “before” the catalyst temperature control period is set at the stoichiometric air-fuel ratio (in this case, the oxygen concentration of the exhaust gas is presumably the reference oxygen concentration), it is presumable that the oxygen concentration of the exhaust gas “during” the catalyst temperature control period is smaller than the reference oxygen concentration. In addition, even when the target air-fuel ratio of air-fuel mixture before the catalyst temperature control period is not set at the stoichiometric air-fuel ratio, it is presumable that the oxygen concentration of the exhaust gas during the catalyst temperature control period may be smaller than the reference oxygen concentration.

When the catalyst has the above characteristic, even when the oxygen concentration of the exhaust gas during the catalyst temperature control period is smaller (richer in air-fuel ratio) than the reference oxygen concentration, it is possible to purify nitrogen oxides at a high catalytic conversion efficiency in comparison with the case where the oxygen concentration is larger (leaner in air-fuel ratio) than the reference oxygen concentration. As a result, the control device according to the aspect of the invention is able to appropriately decrease the temperature of the exhaust gas while suppressing a decrease in the catalytic conversion efficiency of nitrogen oxides by the catalyst as much as possible. That is, the control device according to the aspect of the invention is able to appropriately achieve the purpose of control over the temperature of the exhaust gas and the purpose of control over the air-fuel ratio as much as possible.

Note that the catalytic conversion efficiency of the nitrogen oxides may be a value that indicates the degree to which nitrogen oxides are purified and is not specifically limited. For example, the catalytic conversion efficiency of nitrogen oxides may be the rate of the amount of nitrogen oxides contained in the unit amount of the exhaust gas emitted from the catalyst to the amount of nitrogen oxides contained in the unit amount of the exhaust gas introduced into the catalyst. In addition, the decreasing rate of the catalytic conversion efficiency may be a value that indicates the degree to which the catalytic conversion efficiency decreases and is not specifically limited. For example, the decreasing rate of the catalytic conversion efficiency may be a decreasing amount of the catalytic conversion efficiency per unit oxygen concentration when the oxygen concentration of the exhaust gas deviates from the reference oxygen concentration.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view of an internal combustion engine to which a control device according to a first embodiment of the invention is applied;

FIG. 2 is a graph that shows the correlation between a catalytic conversion efficiency of exhaust gas by a catalyst shown in FIG. 1 and an air-fuel ratio;

FIG. 3 is a graph that shows the correlation between an output value of an upstream air-fuel ratio sensor shown in FIG. 1 and an air-fuel ratio;

FIG. 4 is a graph that shows the correlation between an output value of a downstream air-fuel ratio sensor shown in FIG. 1 and an air-fuel ratio;

FIG. 5 is a schematic flow chart that shows the operations of the control device according to the first embodiment of the invention;

FIG. 6 is a time chart that shows an example of control according to a reference example (related art);

FIG. 7 is a time chart that shows an example of control according to the first embodiment;

FIG. 8 is a flow chart that shows a routine executed by the CPU of the control device according to the first embodiment of the invention;

FIG. 9 is a flow chart that shows a routine executed by the CPU of the control device according to the first embodiment of the invention;

FIG. 10 is a flow chart that shows a routine executed by the CPU of the control device according to the first embodiment of the invention;

FIG. 11 is a flow chart that shows a routine executed by the CPU of the control device according to the first embodiment of the invention;

FIG. 12 is a time chart that shows an example of control according to a second embodiment;

FIG. 13 is a flow chart that shows a routine executed by the CPU of a control device according to the second embodiment of the invention;

FIG. 14 is a time chart that shows an example of control according to a third embodiment;

FIG. 15 is a flow chart that shows a routine executed by the CPU of a control device according to the third embodiment of the invention;

FIG. 16 is a flow chart that shows a routine executed by the CPU of the control device according to the third embodiment of the invention;

FIG. 17 is a time chart that shows an example of control according to a fourth embodiment;

FIG. 18 is a flow chart that shows a routine executed by the CPU of a control device according to the fourth embodiment of the invention;

FIG. 19 is a time chart that shows an example of control according to a fifth embodiment; and

FIG. 20 is a flow chart that shows a routine executed by the CPU of a control device according to the fifth embodiment of the invention.

### DETAILED DESCRIPTION OF EMBODIMENTS

Hereinafter, embodiments (first to fifth embodiments) of a control device for an internal combustion engine according to the aspect of the invention will be described with reference to the accompanying drawings.

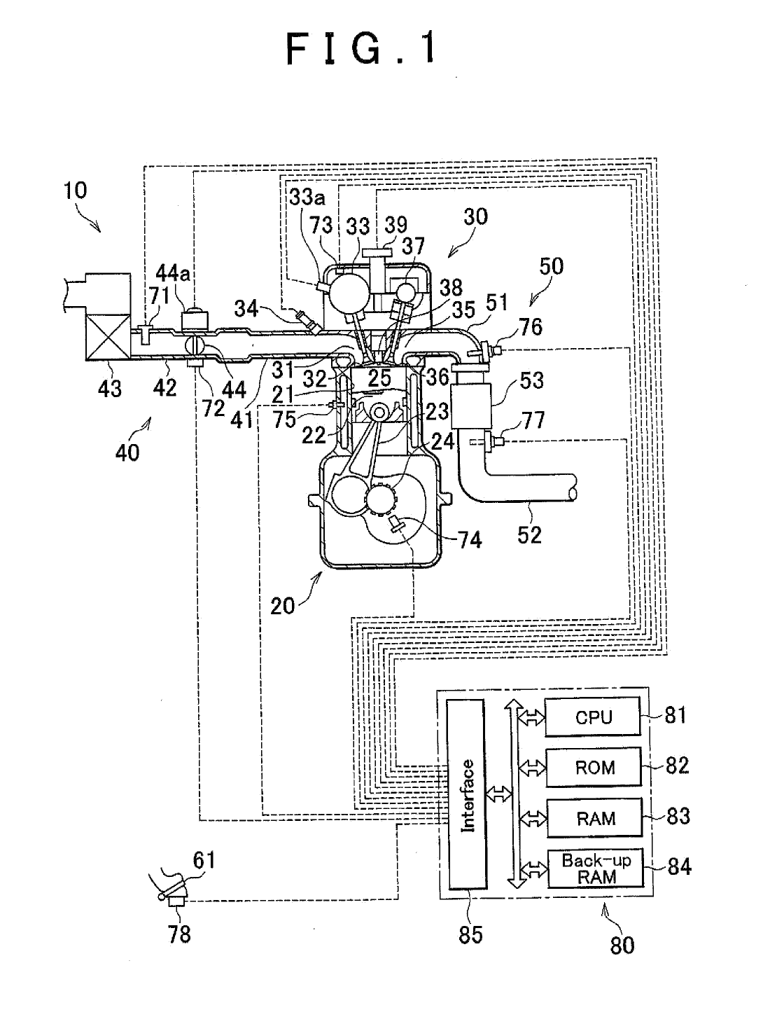

FIG. 1 shows the schematic configuration of a system in which a control device (hereinafter, also referred to as “first device”) according to the first embodiment of the invention is applied to an internal combustion engine 10. The internal combustion engine 10 is a four-cycle spark ignition multi-cylinder (four-cylinder) engine. FIG. 1 shows only the cross-sectional view of one cylinder among a plurality of cylinders. Note that the other cylinders each has a similar configuration to that of the one cylinder. Hereinafter, the “internal combustion engine 10” is also simply referred to as “engine 10”.

The engine 10 includes a cylinder block unit 20, a cylinder head unit 30, an intake system 40, an exhaust system 50, an accelerator pedal 61, various sensors 71 to 78 and an electronic control unit 80. The cylinder head unit 30 is fixed to the top of the cylinder block unit 20. The intake system 40 is used to introduce gas (air-fuel mixture), which is a mixture of air and fuel, into the cylinder block unit 20. The exhaust system 50 is used to emit gas (exhaust gas), discharged from the cylinder block unit 20, to the outside of the engine 10.

The cylinder block unit 20 has cylinders 21, pistons 22, connecting rods 23 and a crankshaft 24. Each piston 22 reciprocally moves in a corresponding one of the cylinders 21, and reciprocal movement of each piston 22 is transmitted to the crankshaft 24 via the corresponding connecting rod 23 to thereby rotate the crankshaft 24. The inner wall surfaces of the cylinders 21, the upper surfaces of the pistons 22 and the lower surface of the cylinder head unit 30 define combustion chambers 25.

The cylinder head unit 30 includes intake ports 31, intake valves 32, a variable intake timing device 33, an actuator 33a of the variable intake timing device 33, injectors 34, exhaust ports 35, exhaust valves 36, an exhaust camshaft 37, ignition plugs 38 and igniters 39. The intake ports 31 are respectively in fluid communication with the combustion chambers 25. The intake valves 32 respectively open or close the corresponding intake ports 31. The variable intake timing device 33 has an intake camshaft that drives the intake valves 32, and continuously varies the phase and lift of the intake camshaft. The injectors 34 respectively inject fuel into the corresponding intake ports 31. The exhaust ports 35 are respectively in fluid communication with the combustion chambers 25. The exhaust valves 36 open or close the corresponding exhaust ports 35. The exhaust camshaft 37 drives the exhaust valves 36. The igniters 39 each include an ignition coil that generates high voltage applied to the corresponding ignition plug 38.

The intake system 40 includes an intake manifold 41, an intake pipe 42, an air cleaner 43, a throttle valve (intake throttle valve) 44 and a throttle valve actuator 44a. The intake manifold 41 is in fluid communication with each of the cylinders via the corresponding intake port 31. The intake pipe 42 is connected to the upstream-side collecting portion of the intake manifold 41. The air cleaner 43 is provided at the end portion of the intake pipe 42. The throttle valve 44 is able to vary the opening area (opening cross-sectional area) of the intake pipe 42. The throttle valve actuator 44a rotationally drives the throttle valve 44 in response to a command signal. The intake ports 31, the intake manifold 41 and the intake pipe 42 constitute an intake passage.

The exhaust system 50 includes an exhaust manifold 51, an exhaust pipe 52 and an exhaust gas purification catalyst 53. The exhaust manifold 51 is in fluid communication with each of the cylinders via the corresponding exhaust port 35. The exhaust pipe 52 is connected to the downstream-side collecting portion of the exhaust manifold 51. The exhaust gas purification catalyst 53 is provided in the exhaust pipe 52. The exhaust ports 35, the exhaust manifold 51 and the exhaust pipe 52 constitute an exhaust passage. Hereinafter, the exhaust gas purification catalyst 53 is also simply referred to as “catalyst 53”.

The catalyst 53 is a three-way catalyst that includes a ceria-zirconia co-catalyst (CeO₂—ZrO₂) that serves as an oxygen storage substance, a ceramic, such as alumina, that serves as a carrier and a noble metal, such as platinum and rhodium, that serves as a catalyst component. When the temperature of the catalyst 53 is higher than or equal to a predetermined activating temperature and the oxygen concentration of exhaust gas introduced into the catalyst 53 is close to a reference oxygen concentration (as described above, the oxygen concentration of exhaust gas that arises when air-fuel mixture having a stoichiometric air-fuel ratio burns), the catalyst 53 facilitates the oxidation-reduction reaction between unburned substances (such as HC) and nitrogen oxides (NOx) in the exhaust gas to thereby make it possible to purify these substances at a high catalytic conversion efficiency.

Hereinafter, the oxygen concentration of exhaust gas is also referred to as “the air-fuel ratio of exhaust gas”, and the fact that the oxygen concentration of exhaust gas is the oxygen concentration of gas that arises at the time when air-fuel mixture having a stoichiometric air-fuel ratio burns is also referred to as “the air-fuel ratio of exhaust gas is a stoichiometric air-fuel ratio”. That is, the fact that the air-fuel ratio of exhaust gas is the stoichiometric air-fuel ratio is substantially synonymous with the fact that the air-fuel ratio of air-fuel mixture introduced into the combustion chambers is the stoichiometric air-fuel ratio. Note that, as described above, an air-fuel ratio that is smaller than the stoichiometric air-fuel ratio is also referred to as “rich air-fuel ratio”, and an air-fuel ratio that is larger than the stoichiometric air-fuel ratio is also referred to as “lean air-fuel ratio”.

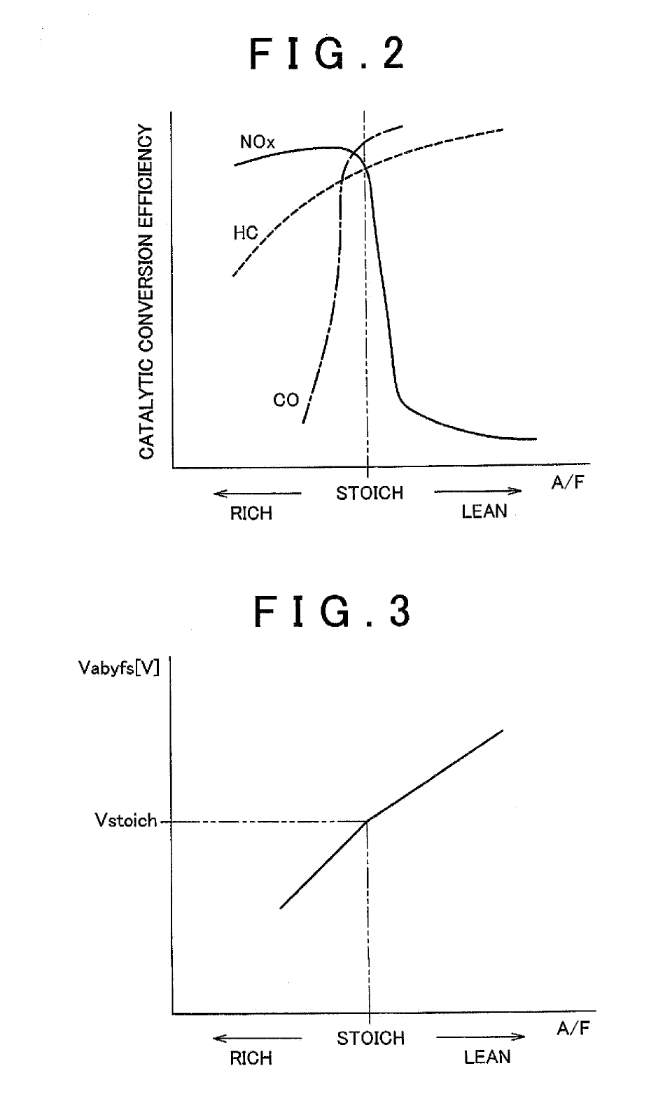

FIG. 2 is a schematic graph that shows the catalytic conversion efficiency of exhaust gas by the catalyst 53 when the temperature of the catalyst 53 is higher than or equal to the activating temperature. As shown in FIG. 2, when the air-fuel ratio A/F of exhaust gas introduced into the catalyst 53 is close the stoichiometric air-fuel ratio stoich, all the nitrogen oxides (NOx) and unburned substances (HC, CO) that are contained in exhaust gas are purified most efficiently. On the other hand, as the air-fuel ratio A/F of exhaust gas deviates from the stoichiometric air-fuel ratio stoich, the catalytic conversion efficiencies of those substances decrease.

Here, for the degree at which the catalytic conversion efficiency of nitrogen oxides (NOx) decreases (decreasing rate), the catalyst 53 has such a characteristic that “the decreasing rate in the ease where the air-fuel ratio A/F of exhaust gas deviates from the stoichiometric air-fuel ratio stoich toward a lean side is higher than the decreasing rate in the case where the air-fuel ratio A/F of exhaust gas deviates from the stoichiometric air-fuel ratio stoich toward a rich side. In other words, the catalytic conversion efficiency of nitrogen oxides (NOx) remarkably decreases when the air-fuel ratio A/F of exhaust gas deviates from the stoichiometric air-fuel ratio stoich toward a lean side; whereas the catalytic conversion efficiency does not decrease to an unacceptable extent in terms of purifying nitrogen oxides (NOx) when the air-fuel ratio A/F deviates from the stoichiometric air-fuel ratio stoich toward a rich side.

In the engine 10, the temperature of the catalyst 53 is acquired (estimated) on the basis of the operating parameters of the engine 10. A method of acquiring (estimating) the temperature of the catalyst 53 will be described in detail later. Then, the temperature of exhaust gas is controlled on the basis of the acquired temperature Tcat of the catalyst 53.

Referring back to FIG. 1, the accelerator pedal 61 is provided outside the engine 10, and is used to input an acceleration request, a required torque, and the like, to the engine 10. The accelerator pedal 61 is operated by the operator of the engine 10.

Furthermore, the various sensors 71 to 78 will be specifically described. The first device includes an intake air mass sensor 71, a throttle valve opening degree sensor 72, a cam position sensor 73, a crank position sensor 74, a fluid temperature sensor 75, an upstream air-fuel ratio sensor 76, a downstream air-fuel ratio sensor 77 and an accelerator operation amount sensor 78.

The intake air mass sensor 71 is provided in the intake passage (intake pipe 42). The intake air mass sensor 71 is configured to output a signal corresponding to the intake air mass that is the mass flow rate of air flowing in the intake pipe 42 (that is, the mass of air taken into the engine 10). On the basis of this signal, a measured intake air mass Ga is acquired.

The throttle valve opening degree sensor 72 is provided near the throttle valve 44. The throttle valve opening degree sensor 72 is configured to output a signal corresponding to the opening degree of the throttle valve 44. On the basis of this signal, a throttle valve opening degree TA is acquired.

The cam position sensor 73 is provided near the variable intake timing device 33. The cam position sensor 73 is configured to output a signal that has one pulse for each rotation of the intake camshaft by 90° (that is, for each rotation of the crankshaft 24 by 180°). On the basis of this signal, the rotational position of the intake camshaft (cam position) is acquired.

The crank position sensor 74 is provided near the crankshaft 24. The crank position sensor 74 is configured to output a signal that has a narrow width pulse for each rotation of the crankshaft 24 by 10° and to output a signal that has a wide width pulse for each rotation of the crankshaft 24 by 360°. On the basis of these signals, the number of revolutions of the crankshaft 24 per unit time (hereinafter, also simply referred to as “engine rotation speed NE”) is acquired.

The fluid temperature sensor 75 is provided in a passage of coolant that flows in the walls of the cylinders 21. The fluid temperature sensor 75 is configured to output a signal corresponding to the temperature of coolant. On the basis of this signal, a measured temperature THW of coolant is acquired.

The upstream air-fuel ratio sensor 76 is provided in the exhaust passage on the upstream side of the catalyst 53 (near the collecting portion of the exhaust manifold 51 or on the downstream side of the collecting portion). The upstream air-fuel ratio sensor 76 is a known limiting current air-fuel ratio sensor. As shown in FIG. 3, the upstream air-fuel ratio sensor 76 is configured to output an output value Vabyfs corresponding to the air-fuel ratio A/F of exhaust gas introduced into the catalyst 53. On the basis of this output value Vabyfs, the air-fuel ratio of exhaust gas introduced into the catalyst 53 is acquired.

Hereinafter, exhaust gas introduced into the catalyst 53 is also referred to as “catalyst introduction gas”. Furthermore, hereinafter, the air-fuel ratio of catalyst introduction gas is also referred to as “catalyst upstream air-fuel ratio abyfs”. In addition, hereinafter, the correlation between the output value Vabyfs and the air-fuel ratio A/F, shown in FIG. 3, is also referred to as “table Mapabyfs”.

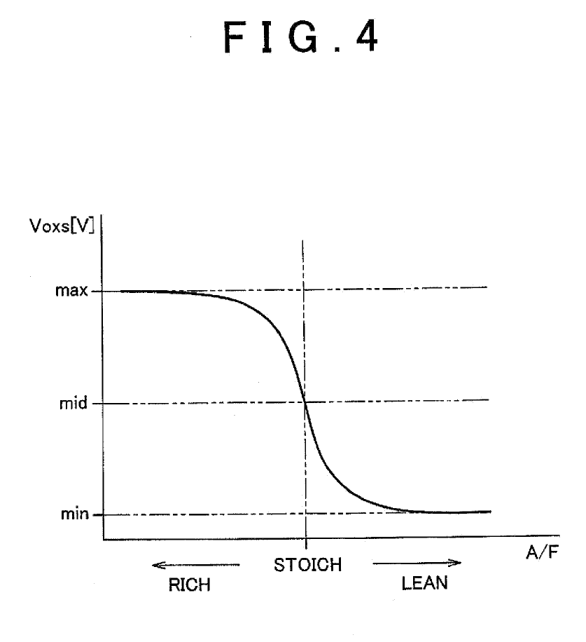

The downstream air-fuel ratio sensor 77 is provided in the exhaust passage on the downstream side of the catalyst 53. The downstream air-fuel ratio sensor 77 is a known electromotive force type (concentration cell type) air-fuel ratio sensor. As shown in FIG. 4, the downstream air-fuel ratio sensor 77 is configured to output an output value Voxs corresponding to the air-fuel ratio of exhaust gas emitted from the catalyst 53. On the basis of this output value Voxs, the air-fuel ratio of exhaust gas emitted from the catalyst 53 is acquired.

Hereinafter, exhaust gas emitted from the catalyst 53 is also referred to as “catalyst emission gas”. Furthermore, hereinafter, the air-fuel ratio of catalyst emission gas is also referred to as “catalyst downstream air-fuel ratio oxs”. On the basis of the thus acquired catalyst upstream air-fuel ratio abyfs and catalyst downstream air-fuel ratio oxs, the air-fuel ratio A/F of air-fuel mixture supplied to the engine 10 is controlled.

Referring back to FIG. 1, the accelerator operation amount sensor 78 is provided for the accelerator pedal 61. The accelerator operation amount sensor 78 is configured to output a signal corresponding to the operation amount of the accelerator pedal 61. On the basis of this signal, an accelerator pedal operation amount Accp is acquired.

Furthermore, the engine 10 includes an electronic control unit 80. The electronic control unit 80 includes a CPU 81, a ROM 82, a RAM 83, a backup RAM 84 and an interface 85. The ROM 82 prestores programs executed by the CPU 81, tables (maps), constants, and the like. The CPU 81, where necessary, temporarily stores data in the RAM 83. The backup RAM 84 stores data in a state where the power is on, and also holds the stored data while the power is interrupted. The interface 85 includes an AD converter. The CPU 81, the ROM 82, the RAM 83, the backup RAM 84 and the interface 85 are connected to one another via a bus.

The interface 85 is connected to the above described sensors, and is configured to transmit signals output from those sensors to the CPU 81. Furthermore, the interface 85 is connected to the actuator 33a of the variable intake timing device 33, the injectors 34, the igniters 39, the throttle valve actuator 44a, and the like, and is configured to transmit command signals to them in response to commands from the CPU 81. The outline of the system in which the first device is applied to the engine 10 is described above.

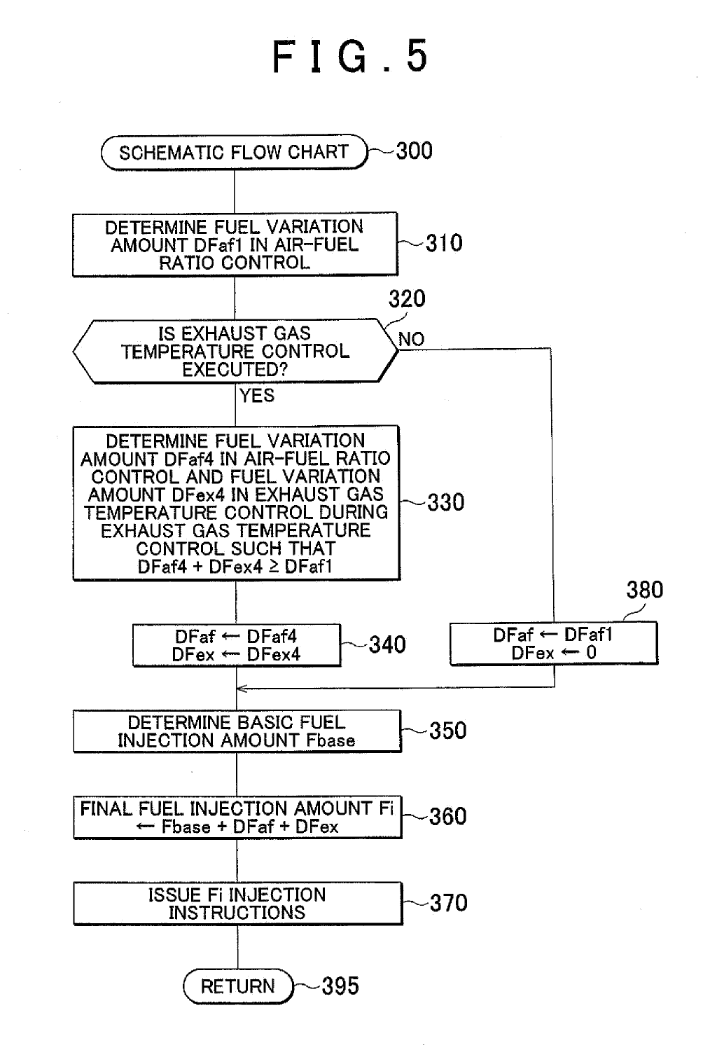

Hereinafter, the outline of operations of the first device will be described with reference to FIG. 5. FIG. 5 is a schematic flow chart that shows the outline of operations of the first device. While air-fuel ratio control is being executed, the first device determines a fuel variation amount DFaf1 for bringing the air-fuel ratio of air-fuel mixture into coincidence with a target air-fuel ratio (in this embodiment, the stoichiometric air-fuel ratio) in step 310. When exhaust gas temperature control is started while air-fuel ratio control is being executed, the first device makes “affirmative determination” in step 320. Then, in step 330, the first device sets a fuel variation amount at the time when exhaust gas temperature control is executed (a fuel variation amount DFaf4 in air-fuel ratio control and a fuel variation amount DFex4 in exhaust gas temperature control).

Specifically, the first device sets the fuel variation amount DFex4 in exhaust gas temperature control and the fuel variation amount DFaf4 in air-fuel ratio control such that “the total (DFex4+DFaf4) of the fuel variation amount DFex4 and the fuel variation amount DFaf4 is larger than or equal to the fuel variation amount (the above described DFaf1) at the time point before exhaust gas temperature control is started or at which exhaust temperature control is started (that is, the time point at or before exhaust gas temperature control is started)”.

Subsequently, in step 360 after passing through step 340 and step 350, the first device adds the thus set fuel variation amounts DFex4 and DFaf4 to a basic fuel injection amount Fbase to thereby determine a final fuel injection amount Fi. Then, in step 370, the first device causes the injector 34 to inject fuel in the final fuel injection amount Fi.

Note that, when exhaust gas temperature control is not executed, the first device makes “negative determination” in step 320. In this case, as shown in step 380, the fuel variation amount in exhaust gas temperature control is zero. Then, in step 360 after passing through step 380 and step 350, the first device adds only the fuel variation amount DFaf1 in air-fuel ratio control to the basic fuel injection amount Fbase to thereby determine the final fuel injection amount Fi. The outline of operations of the first device is described above.

Hereinafter, for the sake of convenience, the fuel variation amount in air-fuel ratio control is also referred to as “air-fuel ratio related variation amount DFaf”, and the fuel variation amount in exhaust gas temperature control is also referred to as “exhaust gas temperature related variation amount DFex”. Furthermore, setting the air-fuel ratio related variation amount DFaf and the exhaust gas temperature related variation amount DFex in accordance with the above described concept is also referred to as “first control method”.

Next, the concept of air-fuel ratio control will be described. Air-fuel ratio control executed by the first device is formed of “main feedback control” and “sub-feedback control”. The main feedback control is executed in order to bring an upstream air-fuel ratio (the air-fuel ratio of catalyst introduction gas) abyfs, obtained on the basis of the output value Vabyfs of the upstream air-fuel ratio sensor 76, into coincidence with a target upstream air-fuel ratio abyfr. The sub-feedback control is executed in order to bring the output value Voxs of the downstream air-fuel ratio sensor 77 into coincidence with a target downstream output value Voxsref.

Specifically, initially, the output value Vabyfs of the upstream air-fuel ratio sensor 76 is corrected by a “sub-feedback amount Vafsfb that is calculated so as to reduce an output deviation amount DVoxs that is the difference between the output value Voxs of the downstream air-fuel ratio sensor 77 and the target downstream output value Voxsref”. Subsequently, an “feedback control output value Vabyfc” obtained through this correction is applied to the table Mapabyfs (see FIG. 3) to thereby calculate a “feedback control air-fuel ratio (corrected detection air-fuel ratio) abyfsc”. Then, the final fuel injection amount Fi is controlled such that the feedback control air-fuel ratio abyfsc coincides with the “target upstream air-fuel ratio abyfr”. Hereinafter, the air-fuel ratio control will be described in more detail.

Note that, as will be described later, a “main feedback amount” calculated in association with main feedback control corresponds to the “air-fuel ratio related variation amount DFaf” used in the first device.

### 1. Main Feedback Control

First, the main feedback control will be described. The first device calculates a feedback control output value Vabyfc(k) at the present time point (time k) in accordance with the following mathematical expression (1). In the following mathematical expression (1), Vabyfs denotes the output value of the upstream air-fuel ratio sensor 76, and Vafsfb denotes the sub-feedback amount calculated on the basis of the output value Voxs of the downstream air-fuel ratio sensor 77. A method of calculating the sub-feedback amount Vafsfb will be described later.

Vabyfc(k)=Vabyfs(k)+Vafsfb(k) (1)

Subsequently, the first device applies the feedback control output value Vabyfc(k) to the table Mapabyfs (see FIG. 3) in accordance with the following mathematical expression (2) to thereby determine the feedback control air-fuel ratio abyfsc(k) at the present time point.

abyfsc(k)=Mapabyfs(Vabyfc(k)) (2)

Subsequently, the first device divides an in-cylinder intake air mass Mc(k), which is the mass of air taken into any one of the cylinders at the present time point, by the target upstream air-fuel ratio abyfr(k) at the present time point in accordance with the following mathematical expression (3) to thereby calculate the basic fuel injection amount Fbase(k) at the present time point. For example, the stoichiometric air-fuel ratio stoich is employed as the target upstream air-fuel ratio abyfr(k).

Fbase(k)=Mc(k)/abyfr(k) (3)

The in-cylinder intake air mass Mc is calculated each time the intake stroke is carried out in each cylinder on the basis of the intake air mass Ga and engine rotation speed NE at that time point. For example, the in-cylinder intake air mass Mc is calculated by dividing a value, obtained by subjecting the intake air mass Ga to first-order lag processing, by the engine rotation speed NE. The in-cylinder intake air mass Mc is stored in the RAM 83 as data associated with each of time points (time k−N, . . . , time k−1, time k, time k+1, . . . ) at which the intake stroke is carried out. Note that the in-cylinder intake air mass Mc may be calculated by a known intake air mass model (model constructed on the basis of the behavior of air in the intake passage).

Subsequently, the first device corrects the basic fuel injection amount Fbase(k) using a main feedback amount DFaf(k) (described later) (adds the main feedback amount DFaf(k) to the basic fuel injection amount Fbase) in accordance with the following mathematical expression (4) to thereby calculate a final fuel injection amount Fi(k). Then, the first device causes the injector 34 of the cylinder, in which the intake stroke is carried out, to inject fuel in the final fuel injection amount Fi(k).

Fi(k)=Fbase(k)+DFaf(k) (4)

In this way, the main feedback amount DFaf is set so as to bring the air-fuel ration of catalyst introduction gas (in other words, the air-fuel ratio of air-fuel mixture) into coincidence with the target air-fuel ratio. That is, the main feedback amount corresponds to the above described “air-fuel ratio related variation amount DFaf”.

The main feedback amount DFaf(k) in the above mathematical expression (4) is calculated as follows. Initially, the first device divides the in-cylinder intake air mass Mc(k−N) at the time point N cycles before the present time point (time k−N) by the feedback control air-fuel ratio (corrected detection air-fuel ratio) abyfsc(k) in accordance with the following mathematical expression (5) to thereby calculate an “in-cylinder fuel supply amount Fc(k−N)” that is the amount of fuel supplied to any one of the combustion chambers 25 at the time point N cycles before the present time point.

Fc(k−N)=Mc(k−N)/abyfsc(k) (5)

Note that, in the above mathematical expression (5), the in-cylinder intake air mass Mc(k−N) at the time point N cycles before the present time point is divided by the feedback control air-fuel ratio abyfsc(k) at the present time point to thereby calculate the in-cylinder fuel supply amount Fc(k−N) at the time point N cycles before the present time point. This is because a period of time corresponding to the N cycles is required by the time when air-fuel mixture burned in any one of the combustion chambers 25 reaches the upstream air-fuel ratio sensor 76.

Subsequently, the first device divides the in-cylinder intake air mass Mc(k−N) at the time point N cycles before the present time point by the target upstream air-fuel ratio abyfr(k−N) at the time point N cycles before the present time point in accordance with the following mathematical expression (6) to thereby calculate a “target in-cylinder fuel supply amount Fcr(k−N)” at the time point N cycles before the present time point.

Fcr(k−N)=Mc(k−N)/abyfr(k−N) (6)

Subsequently, the first device subtracts the in-cylinder fuel supply amount Fc(k−N) from the target in-cylinder fuel supply amount Fcr(k−N) in accordance with the following mathematical expression (7) to thereby calculate an “in-cylinder fuel supply amount deviation DFc(k)”.

DFc(k)=Fcr(k−N)−Fc(k−N) (7)

Subsequently, the first device calculates the main feedback amount DFaf(k) in accordance with the following mathematical expression (8). In the following mathematical expression (8), Gp denotes a preset proportional gain, Gi denotes a preset integral gain, K denotes a predetermined coefficient, and SDFc denotes the integral value of the in-cylinder fuel supply amount deviation DFc.

DFaf(k)=(Gp·DFc(k)+Gi·SDFc(k))·K (8)

As shown in the above mathematical expression (7) and mathematical expression (8), the first device calculates the main feedback amount DFaf(k) through proportional-plus-integral control based on the feedback control air-fuel ratio abyfsc and the target upstream air-fuel ratio abyfr. Then, as shown in the above described mathematical expression (4), the thus calculated main feedback amount DFaf(k) is added to the basic fuel injection amount Fbase to thereby calculate the final fuel injection amount Fi(k). The main feedback control executed by the first device is described above.

### 2. Sub-Feedback Control

Next, the sub-feedback control will be described. The first device subtracts the output value Voxs(k) of the downstream air-fuel ratio sensor 77 at the present time point from a target downstream output value Voxsref(k) at the present time point in accordance with the following mathematical expression (9) to thereby calculate an output deviation amount DVoxs(k) at the present time point. For example, the stoichiometric air-fuel ratio stoich is employed as the target downstream output value Voxsref.

DVoxs(k)=Voxsref(k)−Voxs(k) (9)

Subsequently, the first device calculates a sub-feedback amount Vafsfb(k) at the present time point in accordance with the following mathematical expression (10). In the following mathematical expression (10), Kp denotes a preset proportional gain (proportionality constant), Ki denotes a preset integral gain (integration constant), and SDVoxs denotes the integral value of the output deviation amount DVoxs.

Vafsfb(k)=Kp·DVoxs(k)+Ki·SDVoxs(k) (10)

As shown in the above mathematical expression (9) and mathematical expression (10), the first device calculates the sub-feedback amount Vafsfb through proportional-plus-integral control based on the output value Voxs of the downstream air-fuel ratio sensor 77 and the target downstream output value Voxsref. As shown in the above described mathematical expression (1), the thus calculated sub-feedback amount Vafsfb(k) is added to the output value Vabyfs(k) of the upstream air-fuel ratio sensor 76 to thereby calculate the feedback control output value Vabyfc(k). The sub-feedback control executed by the first device is described above.

### 3. General Overview of Air-Fuel Ratio Control

In this way, the first device adds the sub-feedback amount Vafsfb to the output value Vabyfs of the upstream air-fuel ratio sensor 76 to thereby correct the output value Vabyfs, and then calculates the feedback control air-fuel ratio abyfsc on the basis of the corrected feedback control output value Vabyfc (=Vabyfs+Vafsfb). Then, the first device calculates the fuel injection amount Fi such that the calculated feedback control air-fuel ratio abyfsc coincides with the target upstream air-fuel ratio abyfr. By so doing, the air-fuel ratio of air-fuel mixture supplied to the engine 10 is brought into coincidence with a predetermined target air-fuel ratio (for example, the stoichiometric air-fuel ratio stoich). The air-fuel ratio control executed by the first device is described above.

Next, the concept of exhaust gas temperature control will be described. Exhaust gas temperature control executed by the first device relates to an “estimated temperature that the temperature of the catalyst 53 reaches at the future time point (convergence temperature) Tf”, calculated on the basis of the operating state of the engine 10 at the present time point, and an “estimated temperature of the catalyst 53 at the present time point (current temperature) Tp”, calculated on the basis of the convergence temperature Tf.

Specifically, the first device applies an engine rotation speed NE(k) and load factor KL(k) at the present time point to a convergence temperature table MapTf(NE(k),KL(k)) that presets the “correlation among an engine rotation speed NE, a load factor KL and the convergence temperature Tf of the catalyst 53” to thereby calculate a convergence temperature Tf(k) at the present time point (time k).

The convergence temperature table MapTf(NE(k),KL(k)) may be set on the basis of the result of an experiment conducted in advance, or the like. Note that, as is known, the load factor KL indicates the load condition of the engine 10, and indicates the ratio of the amount of gas actually introduced into any one of the combustion chambers 25 (actual amount) to the maximum amount of gas that may be introduced into that combustion chamber 25 (for example, an amount obtained by dividing the total stroke volume of the engine 10 by the number of the combustion chambers). For example, when the load factor is expressed as a percent, the load factor in the case where the actual amount coincides with the maximum amount is 100%, and the load factor in the case where the actual amount is zero is 0%.

Furthermore, the first device calculates a current temperature Tp(k) in accordance with the following mathematical expression (11). In the following mathematical expression (11), Tp(k) denotes the current temperature at the present time point, Tp(k−1) denotes the current temperature at the time point (time k−1) one cycle before the present time point, and P denotes a predetermined coefficient.

Tp(k)=Tp(k−1)+{Tf−Tp(k−1)}/P (11)

As is understood from the above mathematical expression (11), the current temperature Tp is set so as to gradually approach the convergence temperature Tf with time. Furthermore, as is similarly understood, the current temperature Tp approaches the convergence temperature Tf in a shorter period of time as the coefficient P reduces.

The first device executes exhaust gas temperature control when “both” the thus calculated convergence temperature Tf(k) and current temperature Tp(k) are higher than or equal to a predetermined threshold temperature Tcatth.

Specifically, the first device applies the engine rotation speed NE(k) and intake air mass Ga(k) at the present time point to an exhaust gas temperature related variation amount table MapDFex(NE,Ga) that presets the “correlation among an engine rotation speed NE, an intake air mass Ga and an exhaust gas temperature related variation amount DFex” to thereby calculate an exhaust gas temperature related variation amount DFex(k) at the present time point. The exhaust gas temperature related variation amount DFex is set as an adequate value that can appropriately decrease the temperature of exhaust gas.

Then, the first device corrects the basic fuel injection amount Fbase(k) shown in the above described mathematical expression (3) using the exhaust gas temperature related variation amount DFex(k) (adds the exhaust gas temperature related variation amount DFex(k) to the basic fuel injection amount Fbase(k)) in accordance with the following mathematical expression (12) to thereby calculate the final fuel injection amount Fi(k).

Fi(k)=Fbase(k)+DFex(k) (12)

In this way, when the convergence temperature Tf and current temperature Tp of the catalyst 53 satisfy the predetermined condition, the first device corrects the basic fuel injection amount Fbase so as to be increased by the exhaust gas temperature related variation amount DFex. By so doing, the temperature of exhaust gas is appropriately decreased owing to the fuel cooling effect on the basis of the operating state of the engine 10. The exhaust gas temperature control executed by the first device is described above.

As is understood from the above described air-fuel ratio control and exhaust gas temperature control (particularly, the mathematical expression (4) and the mathematical expression (12)), when “both” the exhaust gas temperature control and the air-fuel ratio control are executed at the same time, the first device corrects the basic fuel injection amount Fbase(k) using the air-fuel ratio related variation amount DFaf(k) and the exhaust gas temperature related variation amount DFex (adds the air-fuel ratio related variation amount DFaf and the exhaust gas temperature related variation amount DFex to the basic fuel injection amount Fbase) in accordance with the following mathematical expression (13) to thereby calculate the final fuel injection amount Fi(k).

Fi(k)=Fbase(k)+DFaf(k)+DFex(k) (13)

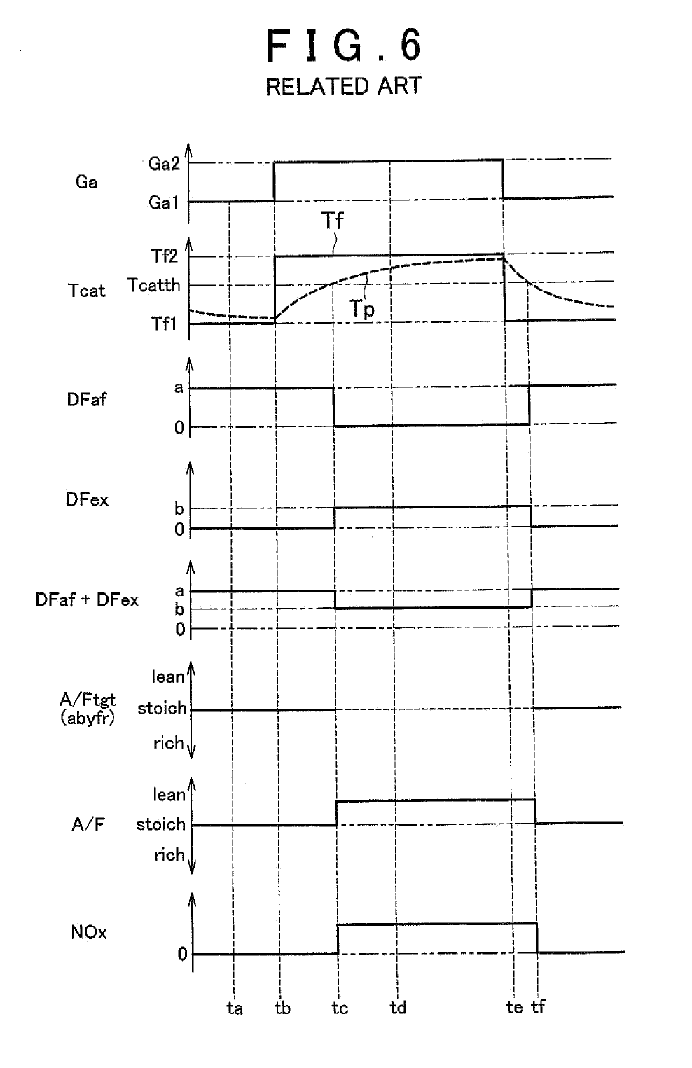

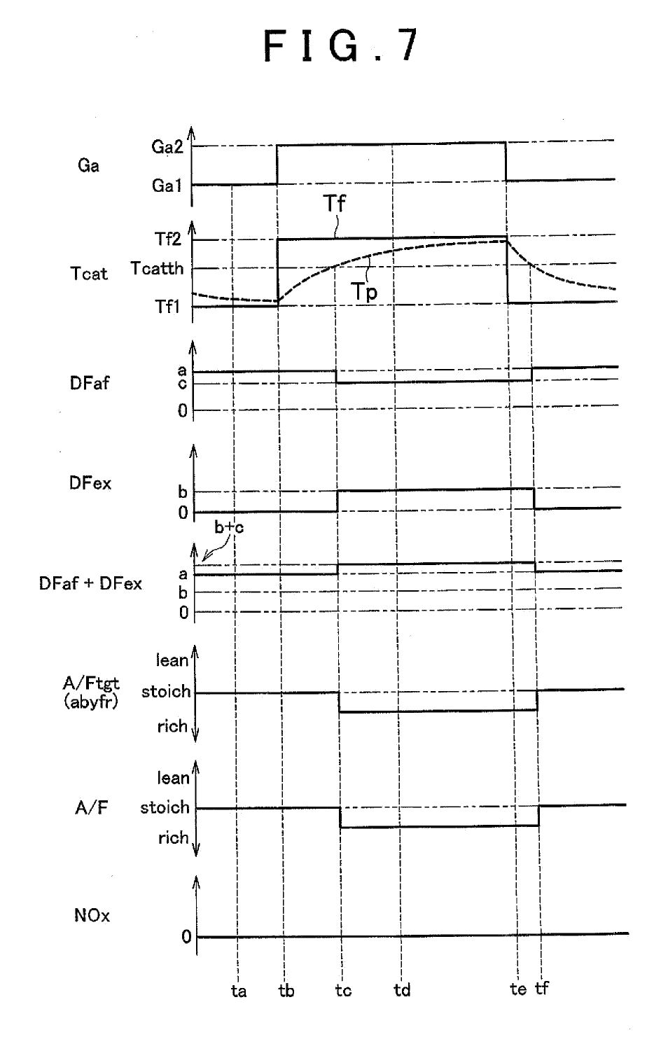

Next, an example of control using the first control method will be described. The first device executes the above described air-fuel ratio control and exhaust gas temperature control in accordance with the above described “first control method”. Hereinafter, an example of a mode in which (both of or one of) air-fuel ratio control and exhaust gas temperature control is executed will be described with reference to FIG. 6 and FIG. 7. FIG. 6 is a time chart that shows an example (reference example) in the case where the first device “does not execute” control according to the first control method. FIG. 7 is a time chart that shows an example in the case where the first device “executes” control according to the first control method. In FIG. 6 and FIG. 7, for the sake of easy understanding, schematic waveforms of the actual waveforms of values are shown. Note that FIG. 6 and FIG. 7 are time charts on the assumption that the air-fuel ratio related variation amount DFaf at the time when air-fuel ratio control is being executed is a positive value.

### 1. Case where Control According to First Control Method is not Executed

### Reference Example

At time ta in the time chart shown in FIG. 6, “only air-fuel ratio control” between air-fuel ratio control and exhaust gas temperature control is being executed.

At time ta, the intake air mass Ga is a value Ga1. On the other hand, for the temperature Tcat of the catalyst 53, the engine rotation speed NE and the load factor KL, which are parameters related to the intake air mass Ga, are applied to the convergence temperature table MapTf(NE,KL) to thereby calculate the convergence temperature Tf (solid line in the chart) of the catalyst 53 at time ta. At time ta, the convergence temperature Tf is a value Tf1. The value Tf1 is lower than the threshold temperature Tcatth. Furthermore, the convergence temperature Tf is applied to the above described mathematical expression (11) to thereby calculate the current temperature Tp (broken line in the chart) of the catalyst 53. At time ta, the current temperature Tp is lower than the threshold temperature Tcatth.

At time ta, the air-fuel ratio related variation amount DFaf set in accordance with the above described air-fuel ratio control is a value a. On the other hand, exhaust gas temperature control is not being executed at time ta, so the exhaust gas temperature related variation amount DFex is zero. Thus, at time ta, the total DFaf+DFex of the air-fuel ratio related variation amount DFaf and the exhaust gas temperature related variation amount DFex is the value a.

At time ta, the target air-fuel ratio A/Ftgt (which is synonymous with the target upstream air-fuel ratio abyfr) of air-fuel mixture is set at the stoichiometric air-fuel ratio stoich. In the present embodiment, the actual air-fuel ratio A/F at time ta coincides with the stoichiometric air-fuel ratio stoich that is the target air-fuel ratio. Note that the above described value a of the air-fuel ratio related variation amount DFaf is set such that the actual air-fuel ratio A/F coincides with the target air-fuel ratio (stoichiometric air-fuel ratio stoich).

As described above, the catalyst 53 is able to efficiently purify exhaust gas when the air-fuel ratio of exhaust gas (which is synonymous with the air-fuel ratio of air-fuel mixture) is the stoichiometric air-fuel ratio. Among others, focusing on nitrogen oxides (NOx) contained in exhaust gas, the air-fuel ratio of air-fuel mixture at time ta is the stoichiometric air-fuel ratio stoich, so the amount of nitrogen oxides (NOx) contained in gas emitted from the engine 10 is close to zero. Hereinafter, the amount of nitrogen oxides contained in gas emitted from the engine 10 is also referred to as “NOx emission”.

After that, at time tb, the intake air mass Ga increases from the value Ga1 to a value Ga2. At this time, the convergence temperature Tf associated with the intake air mass Ga also increases from the value Tf1 to a value Tf2. The value Tf2 is higher than the threshold temperature Tcatth. On the other hand, the current temperature Tp increases so as to gradually approach the convergence temperature Tf2 in accordance with the above described mathematical expression (11) (that is, does not steeply vary), so the current temperature Tp is close to the value Tf1 at time tb.

At time tb, as in the case of the above, the air-fuel ratio related variation amount DFaf is the value a, and the exhaust gas temperature related variation amount DFex is zero. Note that, actually, the intake air mass Ga is varied at time tb, so the air-fuel ratio related variation amount DFaf may increase in order to keep the air-fuel ratio of air-fuel mixture at the stoichiometric air-fuel ratio stoich. However, in the present embodiment, for the sake of easy understanding, it is assumed that the air-fuel ratio related variation amount DFaf does not substantially vary before and after time tb.

After that, the current temperature Tp increases with time, and is higher than or equal to the threshold temperature Tcatth at time tc. That is, at time tc, “both” the convergence temperature Tf and the current temperature Tp are higher than or equal to the threshold temperature Tcatth. At this time, in the present embodiment, air-fuel ratio control is “stopped”, and exhaust gas temperature control is “started”.

As a result, at time tc, the air-fuel ratio related variation amount DFaf reduces from the value a to zero, and the exhaust gas temperature related variation amount DFex increases from zero to a value b. Thus, at time tc, the total DFaf+DFex varies from the value a to the value b.

In the present embodiment, it is assumed that the value b is smaller than the value a. In accordance with this assumption, the total DFaf+DFex (value b) at time tc is smaller than the total DFaf+DFex (value a) at the time point before time to (for example, time to or time tb). Therefore, at time to, the actual air-fuel ratio A/F varies to a value larger than the stoichiometric air-fuel ratio stoich (lean value). Note that, at time tc, air-fuel ratio control is stopped, so the target air-fuel ratio A/Ftgt is not set (see the broken line in the chart).

As a result, at time tc, the air-fuel ratio of exhaust gas is also leaner than the stoichiometric air-fuel ratio stoich. Therefore, the fuel cooling effect cannot be appropriately obtained, and the temperature of exhaust gas is not appropriately decreased. Furthermore, as described above, when the air-fuel ratio of exhaust gas deviates from the stoichiometric air-fuel ratio stoich toward a lean side, the conversion efficiency of nitrogen oxides (NOx) remarkably decreases. Therefore, at time tc, the NOx emission increases. After that, during a period when the intake air mass Ga is the value Ga2 (for example, at time td), the state where the NOx emission is increased continues.

After that, at time te, the intake air mass Ga decreases from the value Ga2 to the value Ga1. At this time, the convergence temperature Tf decreases from the value Tf2 to the value Tf1, and the current temperature Tp decreases so as to gradually approach the convergence temperature Tf1

Then, the current temperature Tp is lower than the threshold temperature Tcatth at time tf. That is, at time tf, both the convergence temperature Tf and the current temperature Tp are lower than the threshold temperature Tcatth. At this time, exhaust gas temperature control is “ended”, and air-fuel ratio control (the target air-fuel ratio A/Ftgt is the stoichiometric air-fuel ratio stoich) is “resumed”.

As a result, at time tf, the air-fuel ratio related variation amount DFaf increases from zero to the value a, and the exhaust gas temperature related variation amount DFex reduces from the value b to zero. Thus, at time tf, the total DFaf+DFex varies from the value b to the value a. By so doing, the actual air-fuel ratio A/F is brought into coincidence with the stoichiometric air-fuel ratio stoich, and the NOx emission reduces to a value close to zero.

In this way, when control according to the first control method is not executed, the temperature of exhaust gas may not be appropriately decreased during a period when exhaust gas temperature control is executed. Furthermore, during that period, the NOx emission may increase.

### 2. Case where Control According to First Control Method is Executed

At time ta in the time chart shown in FIG. 7, as in the case of the above, “only air-fuel ratio control” between air-fuel ratio control and exhaust gas temperature control is being executed.

At time ta, as in the case of the above, the intake air mass Ga is the value Ga1, and both the convergence temperature Tf and the current temperature Tp are lower than the threshold temperature Tcatth. Furthermore, at time ta, the target air-fuel ratio A/Ftgt is set at the stoichiometric air-fuel ratio stoich, and the air-fuel ratio related variation amount DFaf is the value a. In addition, the exhaust gas temperature related variation amount DFex is zero. Thus, the total DFaf+DFex is the value a. At time ta, the actual air-fuel ratio A/F coincides with the target air-fuel ratio (stoichiometric air-fuel ratio stoich). As a result, the NOx emission is close to zero.

After that, the intake air mass Ga increases from the value Ga1 to the value Ga2 at time tb, and both the convergence temperature Tf and the current temperature Tp are higher than or equal to the threshold temperature Tcatth at time tc.

At this time, as described above, the total DFaf+DFex (value b) at time to is smaller than the total DFaf+DFex (value a) at the time point before time tc (for example, time to or time tb). Then, in the present embodiment, different from the above described case where control according to the first control method is “not executed”, air-fuel ratio control is “continued”, and exhaust gas temperature control is started.

As a result, at time tc, for example, the air-fuel ratio related variation amount DFaf varies from the value a to a value c, and the exhaust gas temperature related variation amount DFex varies from zero to the value b. Thus, at time tc, the total DFaf+DFex varies from the value a to the value b+c.

Here, the air-fuel ratio related variation amount DFaf (value c) varies on the basis of the basic fuel injection amount Fbase (see the above description of the main feedback amount), and the like, determined in association with the target air-fuel ratio A/Ftgt. Therefore, on the assumption that the basic fuel injection amount Fbase does not remarkably vary before and after time tb (for example, in the case of a steady state where the operating state of the engine 10 does not substantially vary), it is presumable that the value c is substantially equal to the value a. In accordance with this assumption, the total DFaf+DFex (value b+c) at time tc is larger than the value a. Therefore, at time tc, the actual air-fuel ratio A/F is smaller (richer) than the stoichiometric air-fuel ratio stoich.

As a result, at time tc, the air-fuel ratio of exhaust gas is also richer than the stoichiometric air-fuel ratio stoich. Therefore, the fuel cooling effect is appropriately obtained, and the temperature of exhaust gas is appropriately decreased. Furthermore, as described above, even when the air-fuel ratio of exhaust gas deviates from the stoichiometric air-fuel ratio stoich toward a rich side, the catalytic conversion efficiency of NOx does not decrease to an unacceptable extent. Therefore, at time tc, the NOx emission is substantially kept at a value close to zero.

Note that the target air-fuel ratio A/Ftgt at time tc is appropriately set at an air-fuel ratio (rich air-fuel ratio) smaller than the target air-fuel ratio (stoichiometric air-fuel ratio stoich) at the time point before time tc.

After that, as in the case of the above, the intake air mass Ga reduces from the value Ga2 to the value Ga1 at time te, and both the convergence temperature Tf and the current temperature Tp are lower than the threshold temperature Tcatth at time tf. At this time, the exhaust gas temperature control is ended, and the air-fuel ratio control (the target air-fuel ratio A/Ftgt is the stoichiometric air-fuel ratio stoich) is continued.

In this way, when control according to the first control method of the aspect of the invention is executed, even during a period when exhaust gas temperature control is executed, the temperature of exhaust gas may be appropriately decreased. Furthermore, even during the period, an increase in the NOx emission may be prevented. An example of control according to the first control method is described above.

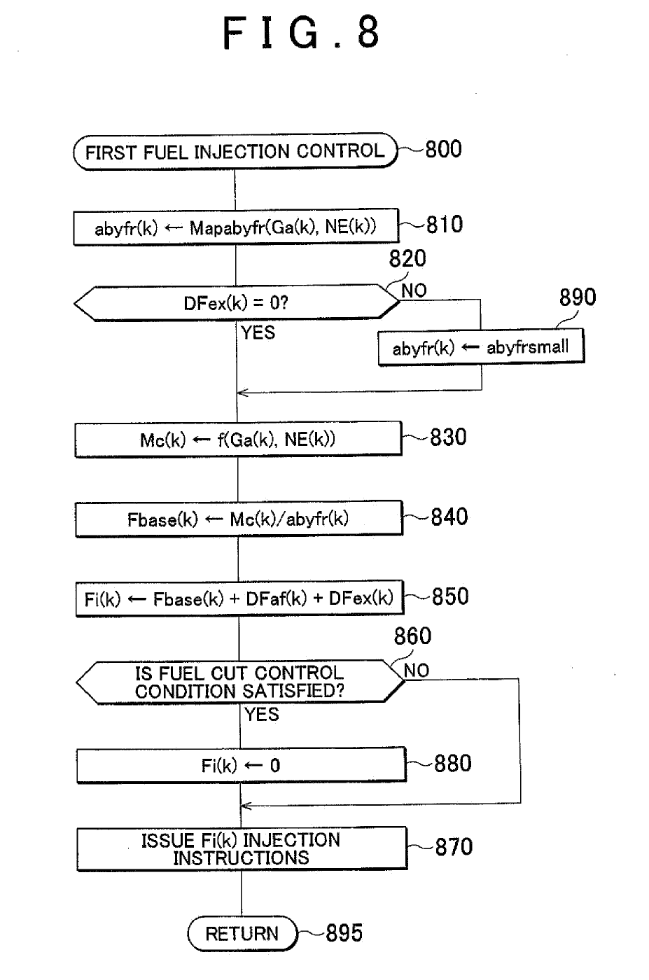

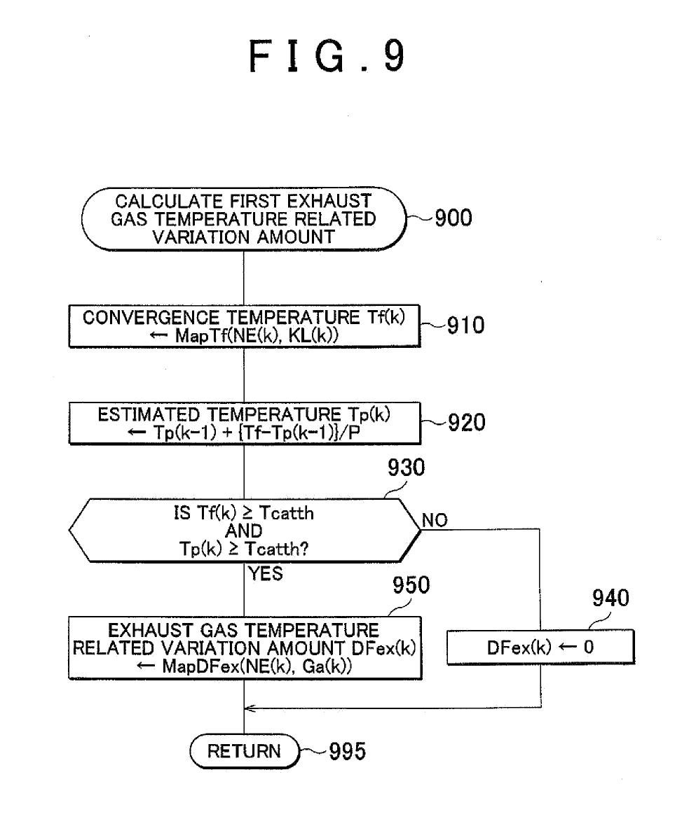

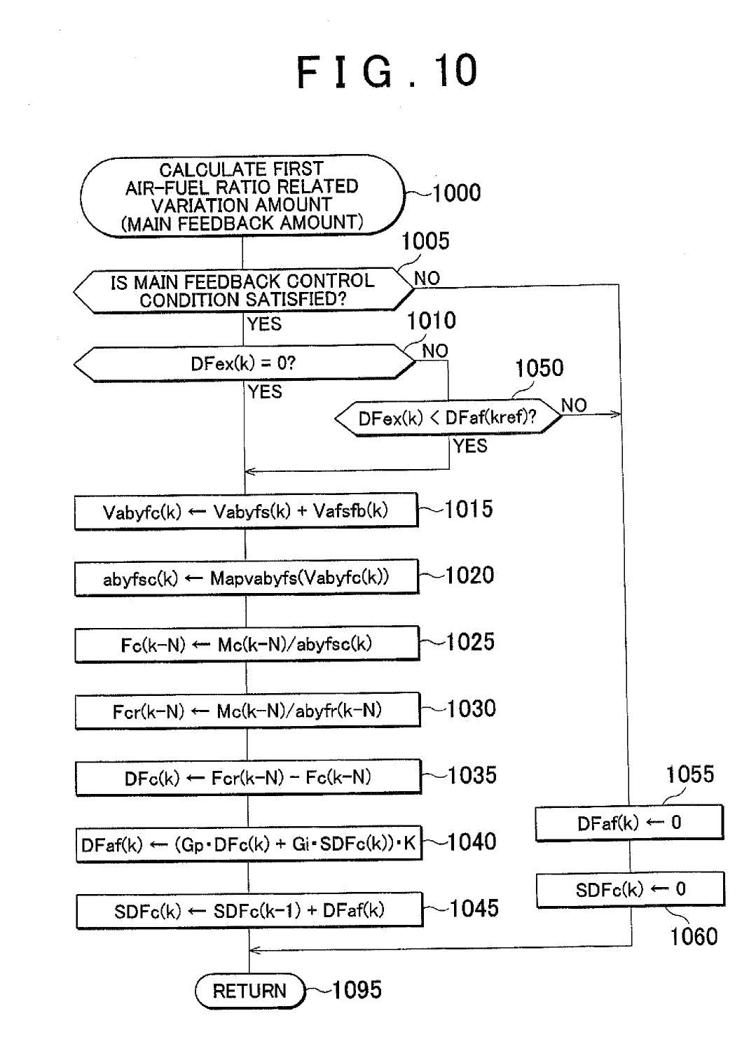

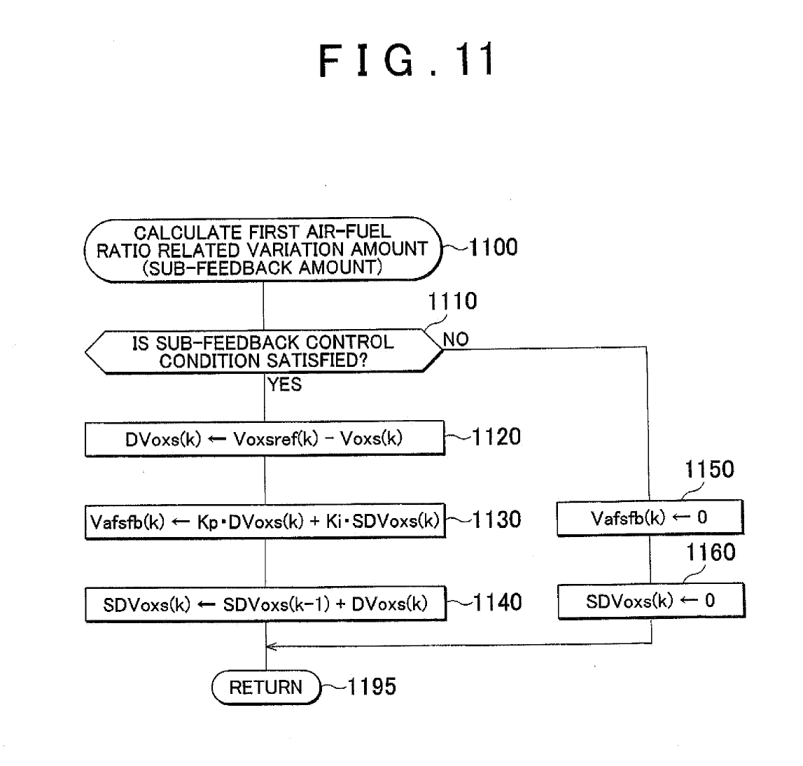

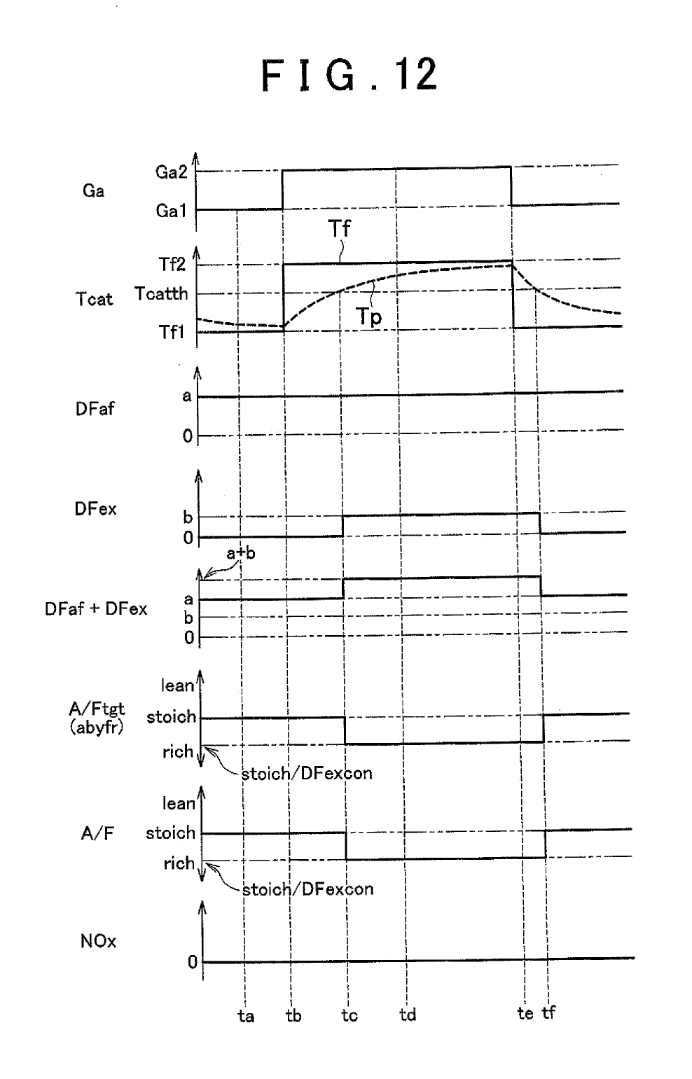

Hereinafter, the actual operations of the first device will be described. In the first device, the CPU 81 repeatedly executes the routines shown in FIG. 8 for control over fuel injection, FIG. 9 for calculation of the exhaust gas temperature related variation amount, FIG. 10 for calculation of the main feedback amount and FIG. 11 for calculation of the sub-feedback amount at each predetermined timing. Hereinafter, the routines executed by the CPU 81 will be described.

First, the CPU 81 repeatedly executes “first fuel injection control routine” shown by the flow chart in FIG. 8 at each timing at which the crank angle of any one of the cylinders coincides with a predetermined crank angle θf before the intake stroke (for example, a crank angle 90 degrees before the exhaust top dead center). Through this routine, the CPU 81 determines the final fuel injection amount Fi in consideration of the air-fuel ratio related variation amount DFaf and the exhaust gas temperature related variation amount DFex, and causes the injector 34 to inject fuel in the final fuel injection amount Fi. Hereinafter, for the sake of convenience, the cylinder before the intake stroke, of which the crank angle coincides with the predetermined crank angle θf, is also referred to as “fuel injection cylinder”.

Specifically, the CPU 81 starts processing from step 800 of FIG. 8 at the above timing and then causes the process to proceed to step 810, and applies the intake air mass Ga(k) and engine rotation speed NE(k) at the present time point (time k) to a target air-fuel ratio table Mapabyfr(Ga,NE), which presets the “correlation among an intake air mass Ga, an engine rotation speed NE and a target upstream air-fuel ratio abyfr” to thereby determine the target air-fuel ratio abyfr(k) at the present time point.

The target upstream air-fuel ratio abyfr is set at an air-fuel ratio at which the catalyst 53 is able to efficiently purify exhaust gas (air-fuel ratio close to the stoichiometric air-fuel ratio stoich). For example, the stoichiometric air-fuel ratio stoich, an air-fuel ratio that is slightly richer than the stoichiometric air-fuel ratio stoich, or the like, is employed as the target air-fuel ratio abyfr. Note that, as described above, the fact that the air-fuel ratio of catalyst introduction gas is the stoichiometric air-fuel ratio stoich is substantially synonymous with the fact that the air-fuel ratio of air-fuel mixture is the stoichiometric air-fuel ratio stoich.

Subsequently, the CPU 81 proceeds to step 820. In step 820, the CPU 81 determines whether the exhaust gas temperature related variation amount DFex(k) is zero (that is, whether exhaust gas temperature control is being executed). Note that setting the exhaust gas temperature related variation amount DFex will be described later (see the routine shown in FIG. 9).

When the exhaust gas temperature related variation amount DFex(k) at the present time point is zero, (that is, when exhaust gas temperature control is not being executed), the CPU 81 makes “affirmative determination” in step 820, and then causes the process to proceed to step 830.

Subsequently, the CPU 81 executes the processes of step 830 to step 850 in this order. The processes executed in step 830 to step 850 are as follows.

In step 830, the CPU 81 acquires the in-cylinder intake air mass Mc(k), which is the mass of air taken into the fuel injection cylinder, on the basis of the intake air mass Ga(k) and the engine rotation speed NE(k). In step 840, the CPU 81 calculates the basic fuel injection amount Fbase(k) in accordance with the above described mathematical expression (3). In step 850, the CPU 81 corrects the basic fuel injection amount Fbase(k) using the air-fuel ratio related variation amount DFaf(k) and the exhaust gas temperature related variation amount DFex(k) in accordance with the above described mathematical expression (4), mathematical expression (12) and mathematical expression (13) to thereby calculate the final fuel injection amount Fi(k).

After the process of step 850 is executed, the CPU 81 causes the process to proceed to step 860, and then determines whether the “condition for executing fuel cut control that sets the fuel injection amount at zero (fuel cut control condition)” is satisfied. More specifically, when both the following conditions a-1 and a-2 are satisfied in step 860, the CPU 81 determines that the fuel cut control condition is satisfied. In other words, when at least one of the following conditions a-1 and a-2 is not satisfied, the CPU 81 determines that the fuel cut control condition is not satisfied.

(a-1) The accelerator pedal operation amount Accp is zero or the throttle valve opening degree TA is zero.

(a-2) The engine rotation speed NE is higher than or equal to a predetermined threshold.

The condition a-1 is provided in order to determine whether the torque required of the engine 10 is sufficiently small. The predetermined threshold in the condition a-2 is set at an adequate value at which it may be determined that the operation of the engine 10 is continued even when the fuel injection amount is zero.

When the fuel cut control condition is “not satisfied” at the present time point, the CPU 81 makes “negative determination” in step 860 and then causes the process to proceed to step 870. In step 870, the CPU 81 issues instructions to cause the injector 34 of the fuel injection cylinder to inject fuel in the final fuel injection amount Fi(k). After that, the CPU 81 causes the process to proceed to step 895 and then once ends the routine. By so doing, fuel in the final fuel injection amount Fi(k) calculated by the above described processes is injected into the fuel injection cylinder.

In contrast to this, when the fuel cut control condition is “satisfied” at the present time point, the CPU 81 makes “affirmative determination” in step 860 and then causes the process to proceed to step 880. In step 880, the CPU 81 stores zero as the value of the final fuel injection amount Fi(k). As a result, even when instructions for injecting fuel in the final fuel injection amount Fi(k) are issued in step 870 subsequent to step 880, fuel is not injected. By so doing, fuel cut operation in which the fuel injection amount is zero is carried out.

Subsequently, the CPU 81 repeatedly executes “first exhaust gas temperature related variation amount calculation routine” shown by the flow chart in FIG. 9 at each timing at which the crank angle of the fuel injection cylinder coincides with the crank angle θf. Through this routine, the CPU 81 calculates the convergence temperature Tf and current temperature Tp of the catalyst 53, and calculates the exhaust gas temperature related variation amount DFex.

Specifically, the CPU 81 starts processing from step 900 of FIG. 9 at the above timing and then causes the process to proceed to step 910, and applies the engine rotation speed NE(k) and load factor KL(k) at the present time point to the above described “convergence temperature table MapTf(NE,KL)” to thereby calculate the convergence temperature Tf(k) of the catalyst 53.

Subsequently, the CPU 81 causes the process to proceed to step 920. In step 920, the CPU 81 calculates the current temperature Tp(k) on the basis of the convergence temperature Tf(k) in accordance with the above described mathematical expression (11). Note that the coefficient P in the above described mathematical expression (11) is set at an adequate value in consideration of the thermal capacity of the catalyst 53, and the like.

Subsequently, the CPU 81 causes the process to proceed to step 930. In step 930, the CPU 81 determines whether to execute exhaust gas temperature control at the present time point. Specifically, the CPU 81 determines whether the convergence temperature Tf(k) and the current temperature Tp(k) respectively satisfy the following conditions b-1 and b-2. In the following conditions b-1 and b-2, Tcatth denotes the predetermined threshold temperature.

(b-1) The convergence temperature Tf(k) is higher than or equal to the threshold temperature Tcatth.

(b-2) The current temperature Tp(k) is higher than or equal to the threshold temperature Tcatth.

In the above conditions b-1 and b-2, the threshold temperature Tcatth is set in consideration of the heat resistance of the catalyst 53, or the like, and is set at an adequate value at which it may be determined that the exhaust gas conversion performance of the catalyst 53 may degrade when both the convergence temperature Tf and the current temperature Tp are higher than or equal to the threshold temperature Tcatth.

When at least one of the above conditions b-1 and b-2 is not satisfied at the present time point, the CPU 81 makes “negative determination” in step 930 and then causes the process to proceed to step 940, and stores zero as the exhaust gas temperature related variation amount DFex(k). After that, the CPU 81 causes the process to proceed to step 995 and then once ends the routine.

In this way, when at least one of the above conditions b-1 and b-2 is not satisfied, the value of the exhaust gas temperature related variation amount DFex for correcting the basic fuel injection amount Fbase is set at zero. That is, in this case, the fuel variation amount is not corrected in order to decrease the temperature of exhaust gas (see step 850 of FIG. 8). In this way, when exhaust gas temperature control is not executed, the value of the exhaust gas temperature related variation amount DFex is set at zero.

On the other hand, when both the above conditions b-1 and b-2 are satisfied at the present time point, the CPU 81 makes “affirmative determination” in step 930 and then causes the process to proceed to step 950. In step 950, the CPU 81 applies the engine rotation speed NE(k) and intake air mass Ga(k) at the present time point to the above described “exhaust gas temperature related variation amount table MapDFex(NE,Ga)” to thereby calculate the exhaust gas temperature related variation amount DFex(k) at the present time point.

Incidentally, the CPU 81 stores the time point at which the result of determination in step 930 varies from “negative determination” to “affirmative determination” (for example, time k) in the RAM 83 as a reference time point kref. Note that the reference time point kref is overwritten (updated) with a new reference time point Kref when the new reference time point Kref is stored in the RAM 83 at a future time point (when the result of determination in step 930 varies from “negative determination” to “affirmative determination” again at a future time point). In other words, the reference time point kref is held in the RAM 83 until the reference time point kref is overwritten with a new reference time point kref.

After that, the CPU 81 causes the process to proceed to step 995 and then once ends the routine. In this way, when both the above conditions b-1 and b-2 are satisfied, the value of the exhaust gas temperature related variation amount DFex is calculated. Then, the basic fuel injection amount Fbase is corrected by this value (see step 850 of FIG. 8).

Furthermore, the CPU 81 repeatedly executes “first air-fuel ratio related variation amount (main feedback amount) calculation routine” shown by the flow chart of FIG. 10 at each timing at which the crank angle of the fuel injection cylinder coincides with a predetermined crank angle θg before the intake stroke (for example, an angle advanced by a predetermined angle from the crank angle θf). Through this routine, the CPU 81 calculates the air-fuel ratio related variation amount DFaf.

Note that, as described above, the air-fuel ratio related variation amount DFaf corresponds to the main feedback amount in the above described mathematical expressions (1) to (13). Then, hereinafter, for the sake of convenience, the air-fuel ratio related variation amount is also referred to as “main feedback amount”.

The routine of FIG. 10 will be more specifically described. The CPU 81 starts processing from step 1000 of FIG. 10 at the above timing and then causes the process to proceed to step 1005, and determines whether the “condition on which feedback control that brings the catalyst upstream air-fuel ratio abyfs into coincidence with the target upstream air-fuel ratio abyfr may be executed (main feedback control condition)” is satisfied. More specifically, in step 1005, the CPU 81 determines that the main feedback control condition is satisfied when all the following conditions c-1 to c-5 are satisfied. In other words, the CPU 81 determines that the main feedback control condition is not satisfied when at least one of the following conditions c-1 to c-5 is not satisfied.

(Condition c-1) The temperature Tcat of the catalyst is higher than or equal to a predetermined activating temperature.

(Condition c-2) The coolant temperature THW is higher than or equal to a predetermined threshold.

(Condition c-3) The intake air mass Ga is lower than or equal to a predetermined threshold.

(Condition c-4) The upstream air-fuel ratio sensor 76 is activated.

(Condition c-5) Fuel cut operation (operation in which the final fuel injection amount Fi is zero) is not being carried out.

The activating temperature in the condition c-1 is set at an adequate value at which it may be determined that the catalyst 53 is activated. The threshold in the condition c-2 is set at an adequate value at which it may be determined that warm-up of the engine 10 is completed. The threshold in the condition c-3 is set at an adequate value at which it may be determined that the load of the engine 10 is not excessively large. The condition c-4 is set because the output value Vabyfs of the upstream air-fuel ratio sensor 76 is used in main feedback control. The condition c-5 is provided because the fuel injection amount Fi cannot be varied during fuel cut operation.

When the main feedback control condition is “satisfied” at the present time point, the CPU 81 makes “affirmative determination” in step 1005 and then causes the process to proceed to step 1010. In step 1010, the CPU 81 determines whether the exhaust gas temperature related variation amount DFex(k) is zero (that is, whether exhaust gas temperature control is being executed).

When the exhaust gas temperature related variation amount DFex(k) at the present time point is zero (that is, when exhaust gas temperature control is not being executed), the CPU 81 makes “affirmative determination” in step 1010. Subsequently, the CPU 81 executes the processes of step 1015 to step 1045 subsequent to step 1010 in this order. The processes executed in step 1015 to step 1045 are as follows.

In step 1015, the CPU 81 calculates the feedback control output value Vabyfc(k) in accordance with the above described mathematical expression (1). The sub-feedback amount Vafsfb(k) at the present time point is calculated in the routine shown in FIG. 11 (described later).

In step 1020, the CPU 81 determines the feedback control air-fuel ratio abyfsc(k) in accordance with the above described mathematical expression (2).

In step 1025, the CPU 81 calculates the in-cylinder fuel supply amount Fc(k−N) at the time point N cycles before the present time point in accordance with the above described mathematical expression (5).

In step 1030, the CPU 81 calculates the target in-cylinder fuel supply amount Fcr(k−N) at the time point N cycles before the present time point in accordance with the above described mathematical expression (6).

In step 1035, the CPU 81 calculates the in-cylinder fuel supply amount deviation DFc(k) in accordance with the above described mathematical expression (7).

In step 1040, the CPU 81 calculates the main feedback amount DFaf(k) in accordance with the above described mathematical expression (8). In the first device, “1” is employed as the coefficient K. The integral value SDFc(k) of the in-cylinder fuel supply amount deviation DFc is a value obtained by integrating the value of the in-cylinder fuel supply amount deviation DFc up to the present time point (see the following step 1045).

In step 1045, the CPU 81 adds the in-cylinder fuel supply amount deviation DFc(k) to the integral value SDFc(k−1) of the in-cylinder fuel supply amount deviation DFc up to the present time point to thereby calculate (update) a new integral value SDFc(k) of the in-cylinder fuel supply amount deviation.

After the process of step 1045 is executed, the CPU 81 causes the process to proceed to step 1095 and then once ends the routine.

Through the above described processes, the main feedback amount DFaf(k) is calculated by proportional-plus-integral control. Then, the final fuel injection amount Fi(k) is corrected using the main feedback amount DFaf(k) (see step 850 of FIG. 8). Note that, because exhaust gas temperature control is not being executed at the present time point (“affirmative determination” is made in step 1010), the final fuel injection amount Fi(k) is corrected using only the main feedback amount DFaf(k).

On the other hand, when the exhaust gas temperature related variation amount DFex(k) at the present time point is not zero (that is, when exhaust gas temperature control is being executed), the CPU 81 makes “negative determination” in step 1010 and then causes the process to proceed to step 1050.

In step 1050, the CPU 81 determines whether the exhaust gas temperature related variation amount DFex(k) at the present time point is smaller than the main feedback amount DFaf(kref) at the reference time point kref.

When the exhaust gas temperature related variation amount DFex(k) at the present time point is larger than or equal to the main feedback amount DFaf(kref) at the reference time point kref, the CPU 81 makes “negative determination” in step 1050 and then causes the process to proceed to step 1055. In step 1055, the CPU 81 stores zero as the main feedback amount DFaf(k) and then causes the process to proceed to step 1060. In step 1060, the CPU 81 stores zero as the integral value SDFc(k) of the in-cylinder fuel supply amount deviation DFc. After that, the CPU 81 causes the process to proceed to step 1095 and then once ends the routine.

In this way, when exhaust gas temperature control is being executed (DFex(k) is not zero) and the exhaust gas temperature related variation amount DFex(k) is larger than or equal to the air-fuel ratio related variation amount DFaf(kref), the air-fuel ratio related variation amount DFaf is set at zero. Therefore, the above described “correcting the basic fuel injection amount Fbase using the main feedback amount DFaf(k)” is not carried out (see step 850 of FIG. 8). That is, air-fuel ratio control is not executed.

In contrast to this, when the exhaust gas temperature related variation amount DFex(k) at the present time point is smaller than the main feedback amount DFaf(kref) at the reference time point kref, the CPU 81 makes “affirmative determination” in step 1050, and, as in the case of the above, executes the processes of step 1015 to step 1045 in this order, causes the process to proceed to step 1095 and then once ends the routine.

In this way, even when exhaust gas temperature control is being executed, when the exhaust gas temperature related variation amount DFex(k) is smaller than the air-fuel ratio related variation amount DFaf(kref), air-fuel ratio control is executed. That is, both air-fuel ratio control and exhaust gas temperature control are executed (see step 850 of FIG. 8).

Note that, when both air-fuel ratio control and exhaust gas temperature control are executed, the CPU 81 makes “negative determination” in step 820 of FIG. 8 and then causes the process to proceed to step 890. In step 890, the CPU 81 stores an “air-fuel ratio abyfrsmall that is smaller than the target upstream air-fuel ratio at the reference time point kref” as the target upstream air-fuel ratio abyfr(k). In this way, in this case, the target upstream air-fuel ratio abyfr(k) is changed to the air-fuel ratio abyfrsmall. The air-fuel ratio abyfrsmall is set at an adequate value in consideration of the exhaust gas temperature related variation amount DFex, or the like.

Incidentally, when the main feedback control condition is “not satisfied” at the present time point, the CPU 81 makes “negative determination” in step 1005 of FIG. 10. Then, the CPU 81 causes the process to proceed to step 1095 via step 1055 and step 1060 and then once ends the routine. By so doing, the main feedback amount DFaf(k) is set at zero. Therefore, in this case, air-fuel ratio control is not executed.

Subsequently, the CPU 81 repeatedly executes “first sub-feedback amount calculation routine” shown by the flow chart in FIG. 11 at each timing at which the crank angle of the fuel injection cylinder coincides with a predetermined crank angle θh before the intake stroke (for example, an angle advanced by a predetermined angle from the crank angle θg). Through this routine, the CPU 81 calculates the sub-feedback amount Vafsfb.

Specifically, the CPU 81 starts processing from step 1100 of FIG. 11 at the above timing and then causes the process to proceed to step 1110, and then determines whether the “condition on which sub-feedback control for bringing the output value Voxs of the downstream air-fuel ratio sensor 77 into coincidence with the target downstream output value Voxsref may be executed (sub-feedback control condition)” is satisfied. More specifically, in step 1110, the CPU 81 determines that the sub-feedback control condition is satisfied when all the following conditions d-1 to d-3 are satisfied. In other words, the CPU 81 determines that the sub-feedback control condition is not satisfied when at least one of the following conditions d-1 to d-3 is not satisfied.

(Condition d-1) The above main feedback control condition is satisfied.

(Condition d-2) The target upstream air-fuel ratio abyfr is set at the stoichiometric air-fuel ratio stoich.

(Condition d-3) The downstream air-fuel ratio sensor 77 is activated.

The condition d-1 is provided because sub-feedback control is executed in parallel with main feedback control. The condition d-2 is provided in consideration of the characteristics of the output value of the downstream air-fuel ratio sensor 77 (see FIG. 4). The condition d-3 is provided because the output value Voxs of the downstream air-fuel ratio sensor 77 is used in sub-feedback control.

When the sub-feedback control condition is satisfied at the present time point, the CPU 81 makes “affirmative determination” in step 1110 and then executes the processes of step 1120 to step 1140 subsequent to step 1110 in this order. The processes executed in step 1120 to step 1140 are as follows.

In step 1120, the CPU 81 calculates the output deviation amount DVoxs(k) in accordance with the above described mathematical expression (9). In the first device, in consideration of the exhaust gas conversion performance of the catalyst 53, an output value corresponding to an air-fuel ratio that is slightly richer than the stoichiometric air-fuel ratio is employed as the target downstream output value Voxsref. In step 1130, the CPU 81 calculates the sub-feedback amount Vafsfb(k) in accordance with the above described mathematical expression (10).

In step 1140, the CPU 81 adds the output deviation amount DVoxs(k) to the integral value SDVoxs(k−1) of the output deviation amount up to the present time point to thereby calculate (update) a new integral value SDVoxs(k) of the output deviation amount.

After the process of step 1140 is executed, the CPU 81 causes the process to proceed to step 1195 and then once ends the routine.

Through the above described processes, the sub-feedback amount Vafsfb(k) is calculated by proportional-plus-integral control (see step 1130). Then, the output value Vabyfs(k) of the upstream air-fuel ratio sensor 76 is corrected using the sub-feedback amount Vafsfb(k) (see step 1015 of FIG. 10). Furthermore, the main feedback amount DFaf(k) is calculated on the basis of the corrected feedback control output value Vabyfs(k) (see step 1040 of FIG. 10), and the final fuel injection amount Fi(k) is corrected using the main feedback amount DFaf(k) (see step 850 of FIG. 8).

In contrast to this, when the sub-feedback control condition is not satisfied at the present time point, the CPU 81 makes “negative determination” in step 1110 and then causes the process to proceed to step 1150. In step 1150, the CPU 81 stores zero as the sub-feedback amount Vafsfb(k). Subsequently, the CPU 81 causes the process to proceed to step 1160. In step 1160, the CPU 81 stores zero as the integral value SDVoxs(k) of the output deviation amount. After that, the CPU 81 causes the process to proceed to step 1195 and then once ends the routine.

In this way, when the sub-feedback control condition is not satisfied, the sub-feedback amount Vafsfb is set at zero. Therefore, in this case, correcting the output value Vabyfs of the upstream air-fuel ratio sensor 76 using the sub-feedback amount Vafsfb is not carried out (see step 1015 of FIG. 10).

As described above, when both the convergence temperature Tf and current temperature Tp of the catalyst 53 are higher than or equal to the threshold temperature Tcatth, the first device executes exhaust gas temperature control (that is, the first device calculates the exhaust gas temperature related variation amount DFex, and corrects the basic fuel injection amount Fbase using the variation amount DFex). At this time, when the exhaust gas temperature related variation amount DFex(k) is smaller than the air-fuel ratio related variation amount DFaf(kref) at the reference time point kref, the first device executes both exhaust gas temperature control and air-fuel ratio control. By so doing, the exhaust gas temperature related variation amount DFex(k) and the air-fuel ratio related variation amount DFaf(k) are set such that the total of the exhaust gas temperature related variation amount DFex(k) and the air-fuel ratio related variation amount DFaf(k) at the present time point is larger than or equal to the air-fuel ratio related variation amount DFaf(kref) at the reference time point kref.

As a result, the amount of fuel in the period during which exhaust gas temperature control is executed is larger than the amount of fuel before exhaust gas temperature control is executed. Therefore, the fuel cooling effect may be appropriately obtained, and the temperature of exhaust gas is appropriately decreased. Furthermore, the air-fuel ratio of catalyst introduction gas in the period during which exhaust gas temperature control is executed is richer than the stoichiometric air-fuel ratio stoich, so the NOx emission is substantially kept at a value close to zero. In this way, the first device is able to appropriately achieve the purpose of exhaust gas temperature control and the purpose of air-fuel ratio control as much as possible.

Note that, as is understood from the above description, irrespective of whether the air-fuel ratio related variation amount DFaf(kref) at the reference time point kref is a positive value or a negative value, the first device is able to set an appropriate air-fuel ratio related variation amount DFaf and an appropriate exhaust gas temperature related variation amount DFex in accordance with the above routines. The first embodiment of the invention is described above.

Next, a control device according to a second embodiment of the invention (hereinafter, also referred to as “second device”) will be described.

The second device is applied to an engine having a similar configuration to that of the engine 10 to which the first device is applied (see FIG. 1, and, hereinafter, for the sake of convenience, referred to as “engine 10”). Then, the description of the outline of the system to which the second device is applied is omitted.

The second device differs from the first device in that, when both exhaust gas temperature control and air-fuel ratio control are executed, the “target upstream air-fuel ratio abyfr is set in consideration of the exhaust gas temperature related variation amount DFex”.

Specifically, when the exhaust gas temperature related variation amount DFex(k) is set, the second device calculates a “value obtained by dividing the sum of the exhaust gas temperature related variation amount DFex(k) and the basic fuel injection amount Fbase(k) by the basic fuel injection amount Fbase(k)”. Furthermore, the second device employs a “value obtained by dividing the target upstream air-fuel ratio abyfr(kref) at the reference time point kref by the calculated value” as the target upstream air-fuel ratio abyfr(k).

The second device executes air-fuel ratio control in accordance with the thus set target upstream air-fuel ratio abyfr(k), and executes exhaust gas temperature control as in the case of the first device. The outline of operations of the second device is described above.

Hereinafter, setting the air-fuel ratio related variation amount DFaf and the exhaust gas temperature related variation amount DFex in accordance with the above described concept is also referred to as “second control method”.

The concept of air-fuel ratio control in the second device differs from the concept of air-fuel ratio control in the first device only in that, when both air-fuel ratio control and exhaust gas temperature control are executed, the target upstream air-fuel ratio abyfr is calculated in accordance with the following mathematical expression (14) and mathematical expression (15). In the following mathematical expression (14) and mathematical expression (15), DFex denotes the exhaust gas temperature related variation amount, Fbase denotes the basic fuel injection amount, and abyfr(kref) denotes the target air-fuel ratio at the reference time point kref.

DFexcon(k)=(DFex(k)+Fbase(k))/Fbase(k) (14)

abyfr(k)=abyfr(kref)/DFexcon(k) (15)

As is understood from the above mathematical expression (14), DFexcon calculated from the mathematical expression is a “value that is obtained by converting the exhaust gas temperature related variation amount DFex into a variation rate with respect to the basic fuel injection amount Fbase”. Hereinafter, for the sake of convenience, the value is also referred to as “conversion value DFexcon”. The conversion value DFexcon increases as the exhaust gas temperature related variation amount DFex increases. Furthermore, as is understood from the above mathematical expression (15), the target air-fuel ratio abyfr calculated from the mathematical expression reduces (becomes richer) as the conversion value DFexcon increases.

For example, when the exhaust gas temperature related variation amount DFex corresponds to 5% of the basic fuel injection amount Fbase, the conversion value DFexcon is 1.05. At this time, for example, when the target air-fuel ratio abyfr(kref) at the reference time point kref is the stoichiometric air-fuel ratio stoich, the target air-fuel ratio abyfr(k) calculated from the above mathematical expression (15) is stoich/1.05.

Here, when the intake air mass Ga at the reference time point kref is equal to the intake air mass Ga at time k, the basic fuel injection amount corresponding to the target air-fuel ratio (stoich/1.05) is 1.05×Ga/stoich. The basic fuel injection amount (1.05×Ga/stoich) is equal to a value obtained by multiplying the basic fuel injection amount (Ga/stoich), corresponding to the original target air-fuel ratio stoich, by the conversion value, that is, 1.05. In this way, when the exhaust gas temperature related variation amount DFex corresponds to 5% of the basic fuel injection amount Fbase, the basic fuel injection amount Fbase is increased by 5% (multiplied by 1.05).

That is, as the amount of fuel is increased by exhaust gas temperature control, the basic fuel injection amount is increased by an amount corresponding to the exhaust gas temperature related variation amount. Thus, when air-fuel ratio control is executed in parallel with exhaust gas temperature control, the final fuel injection amount Fi is reliably increased by an amount required for exhaust gas temperature control (exhaust gas temperature related variation amount DFex). By so doing, the temperature of exhaust gas is appropriately decreased owing to the fuel cooling effect. The exhaust gas temperature control executed by the second device is described above.

The concept of exhaust gas temperature control in the second device is the same as the concept of exhaust gas temperature control in the first device. Then, the description of exhaust gas temperature control in the second device is omitted.

An example of control using the second control method will be described. The second device executes the above described air-fuel ratio control and exhaust gas temperature control in accordance with the above described “second control method”. Hereinafter, an example of a mode in which (both of or one of) air-fuel ratio control and exhaust gas temperature control is executed will be described with reference to FIG. 12. FIG. 12 is a time chart that shows an example in the case where the second device “executes” control according to the second control method. In FIG. 12, for the sake of easy understanding, schematic waveforms of the actual waveforms of values are shown. Note that FIG. 12 is a time chart on the assumption that the air-fuel ratio related variation amount DFaf at the time when air-fuel ratio control is being executed is a positive value.

At time ta in the time chart shown in FIG. 12, only air-fuel ratio control is being executed. At time ta, as in the case of the above, the intake air mass Ga is the value Ga1, and both the convergence temperature Tf and the current temperature Tp are lower than the threshold temperature. Tcatth. Furthermore, at time ta, the target air-fuel ratio A/Ftgt is set at the stoichiometric air-fuel ratio stoich, and the air-fuel ratio related variation amount DFaf is the value a. In addition, the exhaust gas temperature related variation amount DFex is zero. Thus, the total DFaf+DFex is the value a. Thus, the actual air-fuel ratio A/F coincides with the target air-fuel ratio (stoichiometric air-fuel ratio stoich). As a result, the NOx emission is close to zero.

After that, the intake air mass Ga increases from the value Ga1 to the value Ga2 at time tb, and both the convergence temperature Tf and the current temperature Tp are higher than or equal to the threshold temperature Tcatth at time tc. At this time, air-fuel ratio control is “continued”, and exhaust gas temperature control is started.

Specifically, initially, as a result of exhaust gas temperature control, at time tc, the exhaust gas temperature related variation amount DFex varies from zero to the value b. Furthermore, in consideration of the exhaust gas temperature related variation amount DFex, the target air-fuel ratio A/Ftgt at time tc is calculated in accordance with the above described mathematical expression (14) and mathematical expression (15). More specifically, the conversion value DFexcon of the exhaust gas temperature related variation amount DFex (value b) is calculated in accordance with the above described mathematical expression (14). Furthermore, in accordance with the above described mathematical expression (15), a value obtained by dividing the target air-fuel ratio A/Ftgt (stoichiometric air-fuel ratio stoich) at the reference time point kref (in the present embodiment, time ta, time tb or time tc) by the conversion value DFexcon is employed as the target air-fuel ratio A/Ftgt at time tc.

Note that, in the present embodiment, the exhaust gas temperature related variation amount DFex (value b) is a positive value, and the conversion value DFexcon is larger than 1. Thus, the target air-fuel ratio A/Ftgt at time tc (the stoich/DFexcon in FIG. 12) is smaller (richer) than the stoichiometric air-fuel ratio stoich.

Then, the air-fuel ratio related variation amount DFaf is determined such that the target air-fuel ratio A/Ftgt coincides with the actual air-fuel ratio A/F. Here, as described above, even when exhaust gas temperature control and air-fuel ratio control are executed in parallel with each other, the target air-fuel ratio A/Ftgt is a value by which the final fuel injection amount Fi is reliably increased by the exhaust gas temperature related variation amount DFex. Thus, the air-fuel ratio related variation amount DFaf at time tc is the value a that is the same as the value at the time point before time tc.

Therefore, the total DFaf+DFex (a+b) at time tc is larger than the value a. As a result, at time tc, the actual air-fuel ratio A/F is smaller (richer) than the stoichiometric air-fuel ratio stoich.

As a result, at time tc, the actual air-fuel ratio A/F is also richer than the stoichiometric air-fuel ratio stoich. Therefore, the fuel cooling effect may be appropriately obtained, and the temperature of exhaust gas is appropriately decreased. Furthermore, as described above, even when the air-fuel ratio of exhaust gas deviates from the stoichiometric air-fuel ratio stoich toward a rich side, the catalytic conversion efficiency of NOx does not decrease to an unacceptable extent. Therefore, at time tc, the NOx emission is substantially kept at a value close to zero.

After that, as in the case of the above, the intake air mass Ga reduces from the value Ga2 to the value Ga1 at time te, and both the convergence temperature Tf and the current temperature Tp are lower than the threshold temperature Tcatth at time tf. At this time, exhaust gas temperature control is ended, and air-fuel ratio control (the target air-fuel ratio A/Ftgt is the stoichiometric air-fuel ratio stoich) is continued.

In this way, when control according to the second control method of the aspect of the invention is executed, even during a period when exhaust gas temperature control is executed, the temperature of exhaust gas may be appropriately decreased. Furthermore, even during the period, an increase in the NOx emission may be prevented. An example of control according to the second control method is described above.

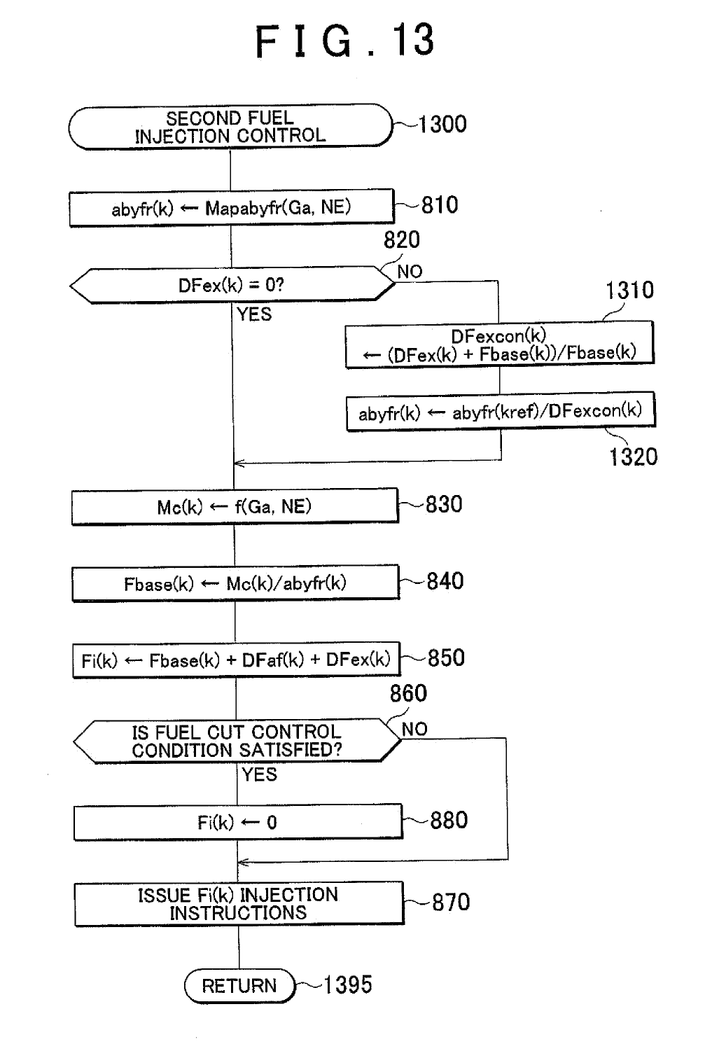

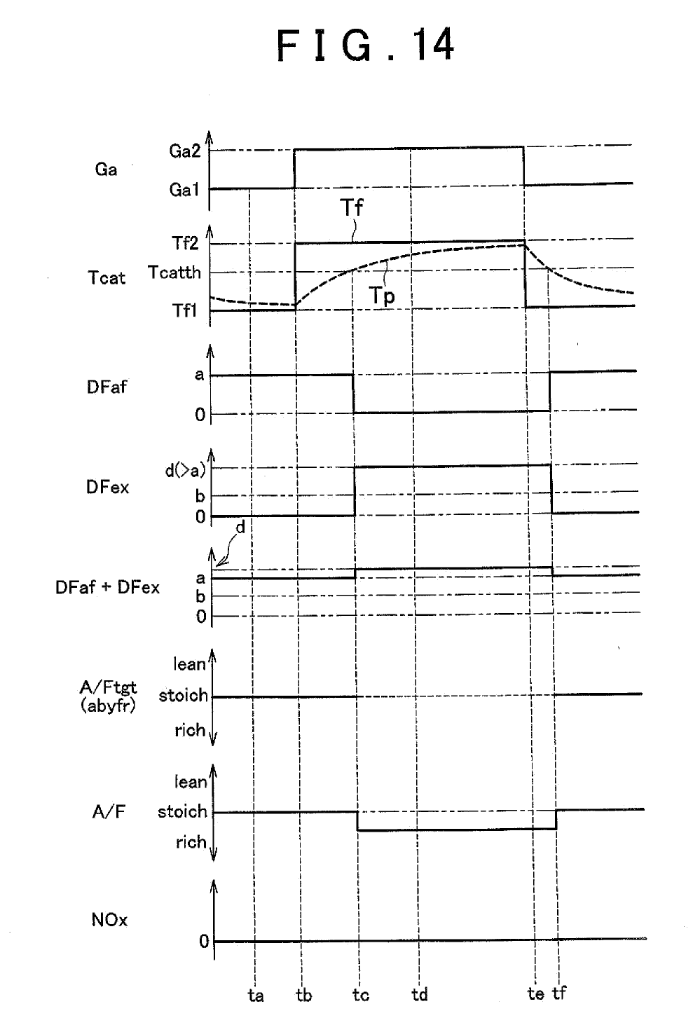

Hereinafter, the actual operations of the second device will be described. In the second device, the CPU 81 repeatedly executes the routines shown in FIG. 13 for control over fuel injection, FIG. 9 for calculation of the exhaust gas temperature related variation amount, FIG. 10 for calculation of the main feedback amount and FIG. 11 for calculation of the sub-feedback amount at each predetermined timing.

The second device differs from the first device only in that the CPU 81 executes the flow chart shown in “FIG. 13” instead of the flow chart shown in FIG. 8. Then, hereinafter, the routines executed by the CPU 81 will be described focusing on the difference.

As in the case of the first device, the CPU 81 repeatedly executes the routine of FIG. 9 at each predetermined timing to thereby calculate the convergence temperature Tf(k) and current temperature Tp(k) of the catalyst 53 and then to determine the exhaust gas temperature related variation amount DFex(k) on the basis of whether both the convergence temperature Tf(k) and the current temperature Tp(k) are higher than or equal to the threshold temperature Tcatth. Furthermore, as in the case of the first device, the CPU 81 repeatedly executes the routines of FIG. 10 and FIG. 11 at each predetermined timing to thereby determine the main feedback amount (air-fuel ratio related variation amount) DFaf(k) in consideration of the exhaust gas temperature related variation amount DFex(k).

Furthermore, the CPU 81 repeatedly executes “second fuel injection control routine” shown by the flow chart in FIG. 13 at each timing at which the crank angle of the fuel injection cylinder coincides with the crank angle θf. Through this routine, as in the case of the routine of FIG. 8, the CPU 81 determines the final fuel injection amount Fi in consideration of the air-fuel ratio related variation amount DFaf and the exhaust gas temperature related variation amount DFex, and causes the injector 34 to inject fuel in the final fuel injection amount Fi.

The routine shown in FIG. 13 differs from the routine shown in FIG. 8 only in that step 1310 and step 1320 are added. Then, like reference signs to those assigned to the steps of FIG. 8 denote steps in FIG. 13 for executing the same processes as those of the steps of FIG. 8. The detailed description of these steps is omitted where appropriate.

Specifically, the CPU 81 starts processing from step 1300 of FIG. 13 at the above timing and then causes the process to proceed to step 810, and then determines the target air-fuel ratio abyfr(k) at the present time point. Subsequently, the CPU 81 causes the process to proceed to step 820, and then determines whether the exhaust gas temperature related variation amount DFex(k) at the present time point is zero (that is, whether exhaust gas temperature control is being executed).

When the exhaust gas temperature related variation amount DFex(k) at the present time point is zero (that is, when exhaust gas temperature control is “not being executed”), the CPU 81 makes “affirmative determination” in step 820 and then executes the processes of step 830 to step 880 as in the case of the first device. By so doing, the basic fuel injection amount Fbase(k) set on the basis of the target upstream air-fuel ratio abyfr(k) is corrected using the main feedback amount DFaf(k) and the exhaust gas temperature related variation amount DFex(k), and fuel in the final fuel injection amount Fi(k) is injected into the fuel injection cylinder.

In contrast to this, when the exhaust gas temperature related variation amount DFex(k) at the present time point is not zero (that is, when exhaust gas temperature control is “being executed”), the CPU 81 makes “negative determination” in step 820 and then causes the process to proceed to step 1310. In step 1310, the CPU 81 calculates the conversion value DFexcon(k) of the exhaust gas temperature related variation amount DFex(k) in accordance with the above described mathematical expression (14).

Subsequently, the CPU 81 causes the process to proceed to step 1320. In step 1320, the CPU 81 stores a value obtained by dividing the target air-fuel ratio abyfr(kref) at the reference time point kref by the conversion value DFexcon(k) in accordance with the above described mathematical expression (15) as the target upstream air-fuel ratio abyfr(k) (updates the target upstream air-fuel ratio abyfr(k) by the obtained value).

After that, the CPU 81 executes the processes of step 830 to step 880 subsequent to step 1320 as in the case of the above. By so doing, the basic fuel injection amount Fbase(k) corresponding to the updated target upstream air-fuel ratio abyfr(k) is calculated (see step 840). Then, the basic fuel injection amount Fbase(k) is corrected by the main feedback amount DFaf(k) and the exhaust gas temperature related variation amount DFex(k), and fuel in the final fuel injection amount Fi(k) is supplied into the fuel injection cylinder.

As described above, when exhaust gas temperature control is being executed (when the exhaust gas temperature related variation amount DFex is not zero), the second device corrects the target upstream air-fuel ratio abyfr on the basis of the exhaust gas temperature related variation amount DFex. As a result, even when exhaust gas temperature control and air-fuel ratio control are executed in parallel with each other, the final fuel injection amount Fi is reliably varied (increased) by an amount required for exhaust gas temperature control (exhaust gas temperature related variation amount DFex). By so doing, the temperature of exhaust gas is appropriately decreased, and the NOx emission is substantially kept at a value close to zero.

Note that, as is understood from the above description, irrespective of whether the air-fuel ratio related variation amount DFaf(kref) at the reference time point kref is a positive value or a negative value, the second device is able to set an appropriate air-fuel ratio related variation amount DFaf and an appropriate exhaust gas temperature related variation amount DFex in accordance with the above routines. The second embodiment of the invention is described above.

Next, a control device according to a third embodiment of the invention (hereinafter, also referred to as “third device”) will be described.

The third device is applied to an engine having a similar configuration to that of the engine 10 to which the first device is applied (see FIG. 1, and, hereinafter, for the sake of convenience, referred to as “engine 10”). Then, the description of the outline of the system to which the third device is applied is omitted.

The third device differs from the first device in that, when exhaust gas temperature control is executed, the “exhaust gas temperature related variation amount DFex is corrected” and “air-fuel ratio control is not executed” where appropriate.

Specifically, when the exhaust gas temperature related variation amount DFex(k) is set and the set exhaust gas temperature related variation amount DFex(k) is smaller than the air-fuel ratio related variation amount DFaf(kref) at the reference time point kref, the third device corrects the exhaust gas temperature related variation amount DFex to a “value larger than or equal to the air-fuel ratio related variation amount DFaf(kref)”.

The third device uses the thus corrected exhaust gas temperature related variation amount DFex(k) to execute exhaust gas temperature control, and “stops” air-fuel ratio control. The outline of operations of the third device is described above.

Hereinafter, setting the air-fuel ratio related variation amount DFaf and the exhaust gas temperature related variation amount DFex in accordance with the above described concept is also referred to as “third control method”.

The concept of air-fuel ratio control in the third device differs from the concept of air-fuel ratio control in the first device only in that, when exhaust gas temperature control is executed, the main feedback amount DFaf is set at zero (that is, air-fuel ratio control is not executed). Then, the detailed description of air-fuel ratio control in the third device is omitted.

In exhaust gas temperature control of the third device, initially, in accordance with a similar concept to that of the first device, the exhaust gas temperature related variation amount DFex at the present time point (time k) is calculated. When the thus calculated exhaust gas temperature related variation amount DFex(k) is smaller than the air-fuel ratio related variation amount DFaf(kref) at the reference time point kref, the third device changes (updates) the exhaust gas temperature related variation amount DFex(k) to (with) a “value DFexlarge larger than or equal to the air-fuel ratio related variation amount DFaf(kref)”.

Then, the third device corrects the basic fuel injection amount Fbase using the changed (updated) exhaust gas temperature related variation amount DFex (that is, DFexlarge) in accordance with the above described mathematical expression (12). The exhaust gas temperature control executed by the third device is described above.

An example of control using the third control method will be described. The third device executes the above described air-fuel ratio control and exhaust gas temperature control in accordance with the above described “third control method”. Hereinafter, an example of a mode in which (both of or one of) air-fuel ratio control and exhaust gas temperature control is executed will be described with reference to FIG. 14. FIG. 14 is a time chart that shows an example in the case where the third device “executes” control according to the third control method. In FIG. 14, for the sake of easy understanding, schematic waveforms of the actual waveforms of values are shown. Note that FIG. 14 is a time chart on the assumption that the air-fuel ratio related variation amount DFaf at the time when air-fuel ratio control is being executed is a positive value.

At time ta in the time chart shown in FIG. 14, only air-fuel ratio control is being executed. At time ta, as in the case of the above, the intake air mass Ga is the value Ga1, and both the convergence temperature Tf and the current temperature Tp are lower than the threshold temperature Tcatth. Furthermore, at time ta, the target air-fuel ratio A/Ftgt is set at the stoichiometric air-fuel ratio stoich, and the air-fuel ratio related variation amount DFaf is the value a. In addition, the exhaust gas temperature related variation amount DFex is zero. Thus, the total DFaf+DFex is the value a. Thus, the actual air-fuel ratio A/F coincides with the target air-fuel ratio (stoichiometric air-fuel ratio stoich). As a result, the NOx emission is close to zero.

After that, the intake air mass Ga increases from the value Ga1 to the value Ga2 at time tb, and both the convergence temperature Tf and the current temperature Tp are higher than or equal to the threshold temperature Tcatth at time tc. At this time, air-fuel ratio control is “stopped”, and exhaust gas temperature control is started.

Specifically, initially, air-fuel ratio control is stopped, so the air-fuel ratio related variation amount DFaf reduces from the value a to zero at time tc. Furthermore, the exhaust gas temperature related variation amount DFex (in the present embodiment, the value b) is set using the exhaust gas temperature related variation amount table MapDFex(NE,Ga). At this time, it is assumed that the exhaust gas temperature related variation amount DFex (value b) is smaller than the air-fuel ratio related variation amount DFaf (value a) at the reference time point kref (in the present embodiment, time ta, time tb or time tc). In accordance with the assumption, as described above, the exhaust gas temperature related variation amount DFex (value b) at time tc is corrected to a value larger than or equal to the air-fuel ratio related variation amount DFaf (value a) at the reference time point kref (in the present embodiment, value d).

Therefore, the total DFaf+DFex (value d) at time tc is larger than the value a. As a result, at time tc, the actual air-fuel ratio A/F is smaller (richer) than the stoichiometric air-fuel ratio stoich. Note that, at time tc, air-fuel ratio control is stopped, so the target air-fuel ratio A/Ftgt is not set (see the broken line in the chart).

As a result, at time tc, the air-fuel ratio of catalyst introduction gas is also richer than the stoichiometric air-fuel ratio stoich. Therefore, the fuel cooling effect may be appropriately obtained, and the temperature of exhaust gas is appropriately decreased. Furthermore, as described above, even when the air-fuel ratio of exhaust gas deviates from the stoichiometric air-fuel ratio stoich toward a rich side, the catalytic conversion efficiency of NOx does not decrease to an unacceptable extent. Therefore, at time tc, the NOx emission is substantially kept at a value close to zero.

After that, as in the case of the above, the intake air mass Ga reduces from the value Ga2 to the value Ga1 at time te, and both the convergence temperature Tf and the current temperature Tp are lower than the threshold temperature Tcatth at time tf. At this time, exhaust gas temperature control is ended, and air-fuel ratio control (the target air-fuel ratio A/Ftgt is the stoichiometric air-fuel ratio stoich) is resumed.

In this way, when control according to the third control method of the aspect of the invention is executed, even during a period when exhaust gas temperature control is executed, the temperature of exhaust gas may be appropriately decreased. Furthermore, even during the period, an increase in the NOx emission may be prevented. An example of control according to the third control method is described above.

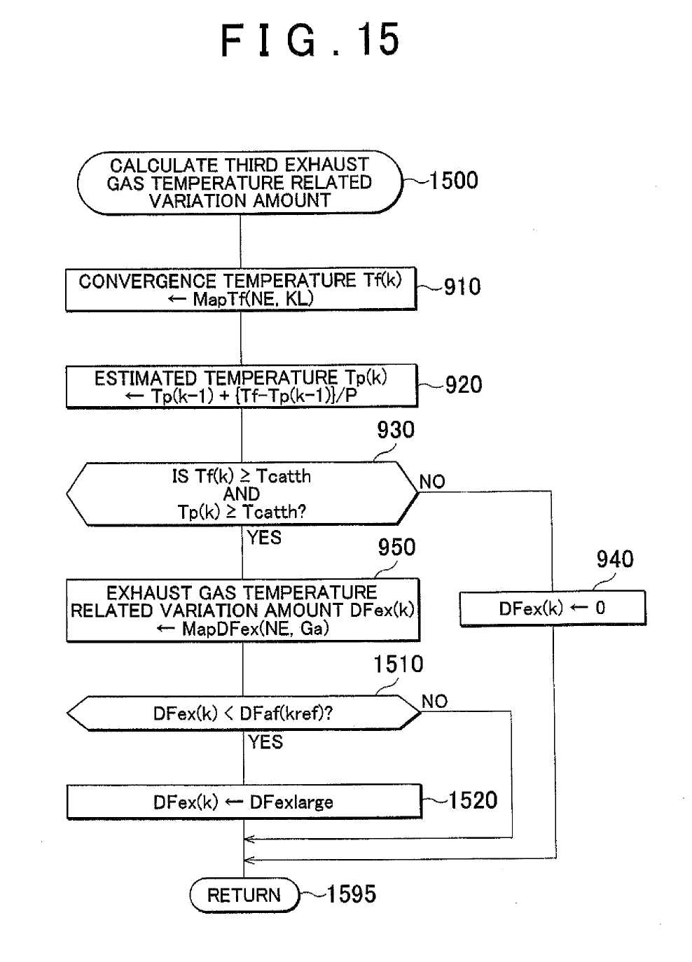

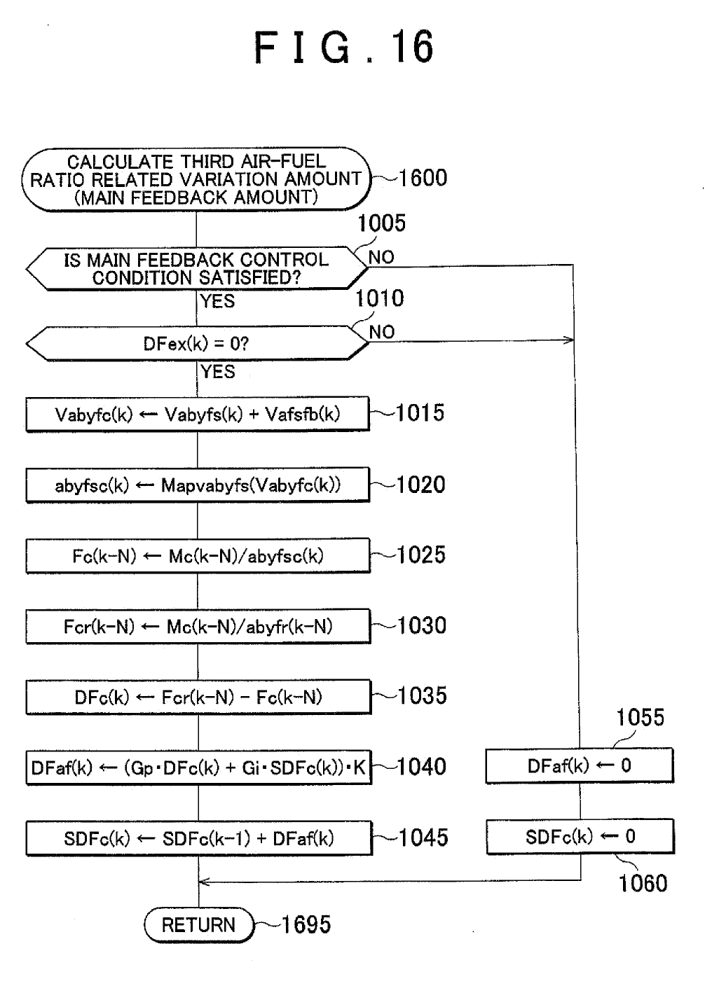

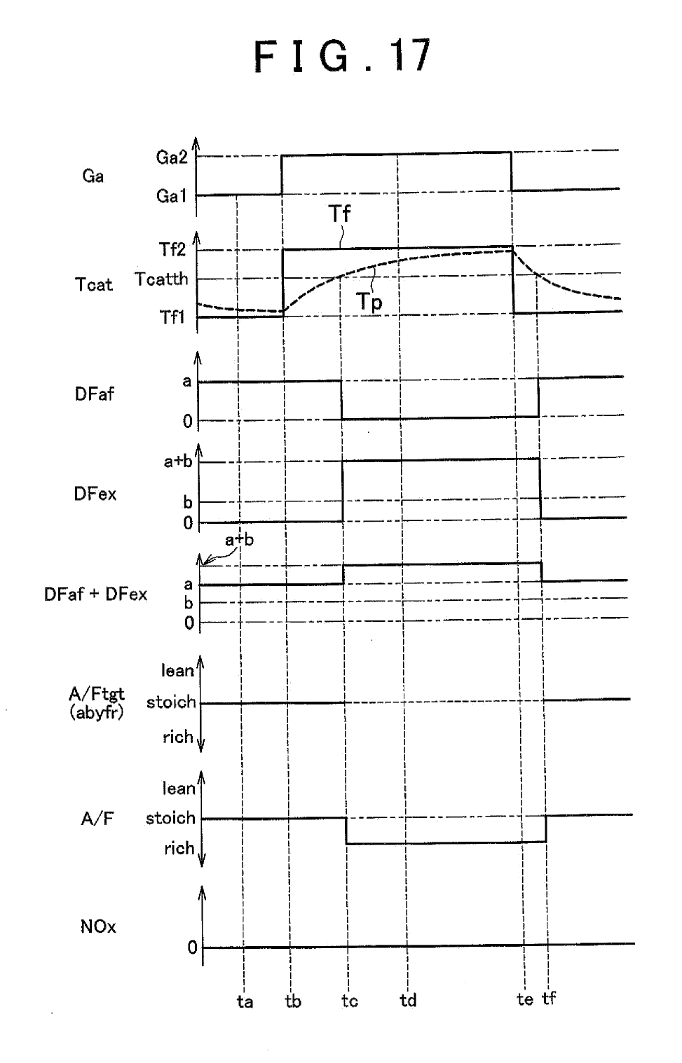

Hereinafter, the actual operations of the third device will be described. In the third device, the CPU 81 repeatedly executes the routines shown in FIG. 8 for control over fuel injection, FIG. 15 for calculation of the exhaust gas temperature related variation amount, FIG. 16 for calculation of the main feedback amount and FIG. 11 for calculation of the sub-feedback amount at each predetermined timing.

The third device differs from the first device only in that the CPU 81 executes the flow chart shown in “FIG. 15” and the flow chart shown in “FIG. 16” instead of the flow chart shown in FIG. 9 and the flow chart shown in FIG. 10. Then, hereinafter, the routines executed by the CPU 81 will be described focusing on the difference.

The CPU 81 repeatedly executes “third exhaust gas temperature related variation amount calculation routine” shown by the flow chart in FIG. 15 at each timing at which the crank angle of the fuel injection cylinder coincides with the crank angle θf. Through this routine, the CPU 81 calculates the exhaust gas temperature related variation amount DFex.

The routine shown in FIG. 15 differs from the routine shown in FIG. 9 only in that step 1510 and step 1520 are added. Then, like reference signs to those assigned to the steps of FIG. 9 denote steps in FIG. 15 for executing the same processes as those of the steps of FIG. 9. The detailed description of these steps is omitted where appropriate.

Specifically, as the CPU 81 starts processing from step 1500 of FIG. 15 at the above timing, the CPU 81 causes the process to proceed to step 930 via step 910 and step 920. Then, when both the convergence temperature Tf(k) and the current temperature Tp(k) are higher than or equal to the threshold temperature Tcatth, the CPU 81 causes the process to proceed to step 950 and then calculates the exhaust gas temperature related variation amount DFex(k).

Subsequently, the CPU 81 causes the process to proceed to step 1510. In step 1510, the CPU 81 determines whether the exhaust gas temperature related variation amount DFex(k) at the present time point is smaller than the main feedback amount DFaf(kref) at the reference time point kref. Note that, as described above, the CPU 81 stores the time point at which the result of determination in step 930 varies from “negative determination” to “affirmative determination” (time k) in the RAM 83 as a reference time point kref.

When the exhaust gas temperature related variation amount DFex(k) at the present time point is “larger than or equal to” the main feedback amount DFaf(kref) at the reference time point kref, the CPU 81 makes “negative determination” in step 1510, causes the process to proceed to step 1595 and then once ends the routine. Thus, in this case, the basic fuel injection amount Fbase(k) is corrected using the exhaust gas temperature related variation amount DFex(k) calculated in step 950 (see step 850 of FIG. 8).

In contrast to this, when the exhaust gas temperature related variation amount DFex(k) at the present time point is “smaller” than the main feedback amount DFaf(kref) at the reference time point kref, the CPU 81 makes “affirmative determination” in step 1510 and then causes the process to proceed to step 1520. In step 1520, the CPU 81 stores a “variation amount DFexlarge that is larger than or equal to the air-fuel ratio related variation amount DFaf(kref) at the reference time point kref” as the exhaust gas temperature related variation amount DFex(k). After that, the CPU 81 causes the process to proceed to step 1595 and then once ends the routine. Thus, in this case, the exhaust gas temperature related variation amount DFex(k) is changed to the variation amount DFexlarge, and the basic fuel injection amount Fbase is corrected using the variation amount DFexlarge (see step 850 of FIG. 8).

Furthermore, the CPU 81 repeatedly executes “third air-fuel ratio related variation amount (main feedback amount) calculation routine” shown by the flow chart in FIG. 16 at each timing at which the crank angle of the fuel injection cylinder coincides with the crank angle θg. Through this routine, the CPU 81 calculates the main feedback amount DFaf.

The routine shown in FIG. 16 differs from the routine shown in FIG. 10 only in that step 1050 is “omitted”. Then, like reference signs to those assigned to the steps of FIG. 10 denote steps in FIG. 16 for executing the same processes as those of the steps of FIG. 10. The detailed description of these steps is omitted where appropriate.

Specifically, as the CPU 81 starts processing from step 1600 of FIG. 16 at the above timing, the CPU 81 causes the process to proceed to step 1010 via step 1005 when the main feedback control condition is satisfied. When the exhaust gas temperature related variation amount DFex(k) at the present time point is zero (that is, when exhaust gas temperature control is not being executed), the CPU 81 makes “affirmative determination” in step 1010, causes the process to proceed to step 1695 via step 1015 to step 1045 and then once ends the routine. By so doing, the main feedback amount DFaf(k) is determined.

On the other hand, when the exhaust gas temperature related variation amount DFex(k) at the present time point is not zero (that is, when exhaust gas temperature control is being executed), the CPU 81 makes “negative determination” in step 1010, causes the process to proceed to step 1695 via step 1055 and step 1060 and then once ends the routine. By so doing, the main feedback amount DFaf(k) is set at zero.

In this way, when exhaust gas temperature control is being executed (when negative determination is made in step 1010), the main feedback amount DFaf(k) is definitely set at zero. That is, air-fuel ratio control is “stopped”.

As described above, when exhaust gas temperature control is being executed (when the exhaust gas temperature related variation amount DFex is not zero), the third device stops air-fuel ratio control. Furthermore, the third device, where necessary, corrects the exhaust gas temperature related variation amount DFex to an “amount that is larger than or equal to the air-fuel ratio related variation amount DFaf at the reference time point kref”. As a result, even when air-fuel ratio control is stopped when exhaust gas temperature control is executed, the final fuel injection amount Fi is reliably varied (increased). By so doing, the temperature of exhaust gas is appropriately decreased, and the NOx emission is substantially kept at a value close to zero.

Note that, as is understood from the above description, irrespective of whether the air-fuel ratio related variation amount DFaf(kref) at the reference time point kref is a positive value or a negative value, the third device is able to set an appropriate exhaust gas temperature related variation amount DFex in accordance with the above routines. The third embodiment of the invention is described above.

Next, a control device according to a fourth embodiment of the invention (hereinafter, also referred to as “fourth device”) will be described.

The fourth device is applied to an engine having a similar configuration to that of the engine 10 to which the first device is applied (see FIG. 1, and, hereinafter, for the sake of convenience, referred to as “engine 10”). Then, the description of the outline of the system to which the fourth device is applied is omitted.

The outline of operations of the fourth device will be described. The fourth device differs from the first device in that, when exhaust gas temperature control is executed, the “exhaust gas temperature related variation amount DFex is corrected” and “air-fuel ratio control is not executed” where necessary. Furthermore, the fourth device differs from the third device in that the “exhaust gas temperature related variation amount DFex is corrected on the basis of the concept different from that of the third device”.

Specifically, when the exhaust gas temperature related variation amount DFex(k) is set and the set exhaust gas temperature related variation amount DFex(k) is smaller than the air-fuel ratio related variation amount DFaf(kref) at the reference time point kref, the fourth device corrects the exhaust gas temperature related variation amount DFex to the “sum of the exhaust gas temperature related variation amount DFex and the air-fuel ratio related variation amount DFaf(kref)”.

The fourth device uses the thus corrected exhaust gas temperature related variation amount DFex(k) to execute exhaust gas temperature control, and “stops” air-fuel ratio control. The outline of operations of the fourth device is described above.

Hereinafter, setting the air-fuel ratio related variation amount DFaf and the exhaust gas temperature related variation amount DFex in accordance with the above described concept is also referred to as “fourth control method”.

The concept of air-fuel ratio control in the fourth device differs from the concept of air-fuel ratio control in the first device only in that, when exhaust gas temperature control is executed, the main feedback amount DFaf is set at zero (that is, air-fuel ratio control is not executed). Then, the detailed description of air-fuel ratio control in the fourth device is omitted.

The exhaust gas temperature control will be described. The fourth device initially calculates the exhaust gas temperature related variation amount DFex at the present time point (time k) in accordance with a similar concept to that of the first device. When the thus calculated exhaust gas temperature related variation amount DFex(k) is smaller than the air-fuel ratio related variation amount DFaf(kref) at the reference time point kref, the fourth device changes (updates) the exhaust gas temperature related variation amount DFex(k) to (with) the “sum of the exhaust gas temperature related variation amount DFex(k) and the air-fuel ratio related variation amount DFaf(kref)”.

Then, the fourth device corrects the basic fuel injection amount Fbase using the changed (updated) exhaust gas temperature related variation amount DFex (that is, DFexlarge) in accordance with the above described mathematical expression (12). The exhaust gas temperature control executed by the fourth device is described above.

An example of control using the fourth control method will be described. The fourth device executes the above described air-fuel ratio control and exhaust gas temperature control in accordance with the above described “fourth control method”. Hereinafter, an example of a mode in which (both of or one of) air-fuel ratio control and exhaust gas temperature control is executed will be described with reference to FIG. 17. FIG. 17 is a time chart that shows an example in the case where the fourth device “executes” control according to the fourth control method. In FIG. 17, for the sake of easy understanding, schematic waveforms of the actual waveforms of values are shown. Note that FIG. 17 is a time chart on the assumption that the air-fuel ratio related variation amount DFaf at the time when air-fuel ratio control is being executed is a positive value.

At time ta in the time chart shown in FIG. 17, only air-fuel ratio control is being executed. At time ta, as in the case of the above, the intake air mass Ga is the value Ga1, and both the convergence temperature Tf and the current temperature Tp are lower than the threshold temperature Tcatth. Furthermore, at time ta, the target air-fuel ratio A/Ftgt is set at the stoichiometric air-fuel ratio stoich, and the air-fuel ratio related variation amount DFaf is the value a. In addition, the exhaust gas temperature related variation amount DFex is zero. Thus, the total DFaf+DFex is the value a. Thus, the actual air-fuel ratio A/F coincides with the target air-fuel ratio (stoichiometric air-fuel ratio stoich). As a result, the NOx emission is close to zero.

After that, the intake air mass Ga increases from the value Ga1 to the value Ga2 at time tb, and both the convergence temperature Tf and the current temperature Tp are higher than or equal to the threshold temperature Tcatth at time tc. At this time, air-fuel ratio control is “stopped”, and exhaust gas temperature control is started.

Specifically, initially, air-fuel ratio control is stopped, so the air-fuel ratio related variation amount DFaf reduces from the value a to zero at time tc. Furthermore, the exhaust gas temperature related variation amount DFex (in the present embodiment, the value b) is set using the exhaust gas temperature related variation amount table MapDFex(NE,Ga). At this time, it is assumed that the exhaust gas temperature related variation amount DFex (value b) is smaller than the air-fuel ratio related variation amount DFaf (value a) at the reference time point kref (in the present embodiment, time ta, time tb or time tc). In accordance with the assumption, as described above, the exhaust gas temperature related variation amount DFex (value b) at time to is corrected to the sum of the exhaust gas temperature related variation amount DFex (value b) and the air-fuel ratio related variation amount DFaf (value a) at the reference time point kref (in the present embodiment, value a+b).

Therefore, the total DFaf+DFex (a+b) at time to is larger than the value a. As a result, at time tc, the actual air-fuel ratio A/F is smaller (richer) than the stoichiometric air-fuel ratio stoich. Note that, at time tc, air-fuel ratio control is stopped, so the target air-fuel ratio A/Ftgt is not set (see the broken line in the chart).

As a result, at time tc, the air-fuel ratio of catalyst introduction gas is also richer than the stoichiometric air-fuel ratio stoich. Therefore, the fuel cooling effect may be appropriately obtained, and the temperature of exhaust gas is appropriately decreased. Furthermore, as described above, even when the air-fuel ratio of exhaust gas deviates from the stoichiometric air-fuel ratio stoich toward a rich side, the catalytic conversion efficiency of NOx does not decrease to an unacceptable extent. Therefore, at time tc, the NOx emission is substantially kept at a value close to zero.

After that, as in the case of the above, the intake air mass Ga reduces from the value Ga2 to the value Ga1 at time te, and both the convergence temperature Tf and the current temperature Tp are lower than the threshold temperature Tcatth at time tf. At this time, exhaust gas temperature control is ended, and air-fuel ratio control (the target air-fuel ratio A/Ftgt is the stoichiometric air-fuel ratio stoich) is resumed.

In this way, when control according to the fourth control method of the aspect of the invention is executed, even during a period when exhaust gas temperature control is executed, the temperature of exhaust gas may be appropriately decreased. Furthermore, even during the period, an increase in the NOx emission may be prevented. An example of control according to the fourth control method is described above.

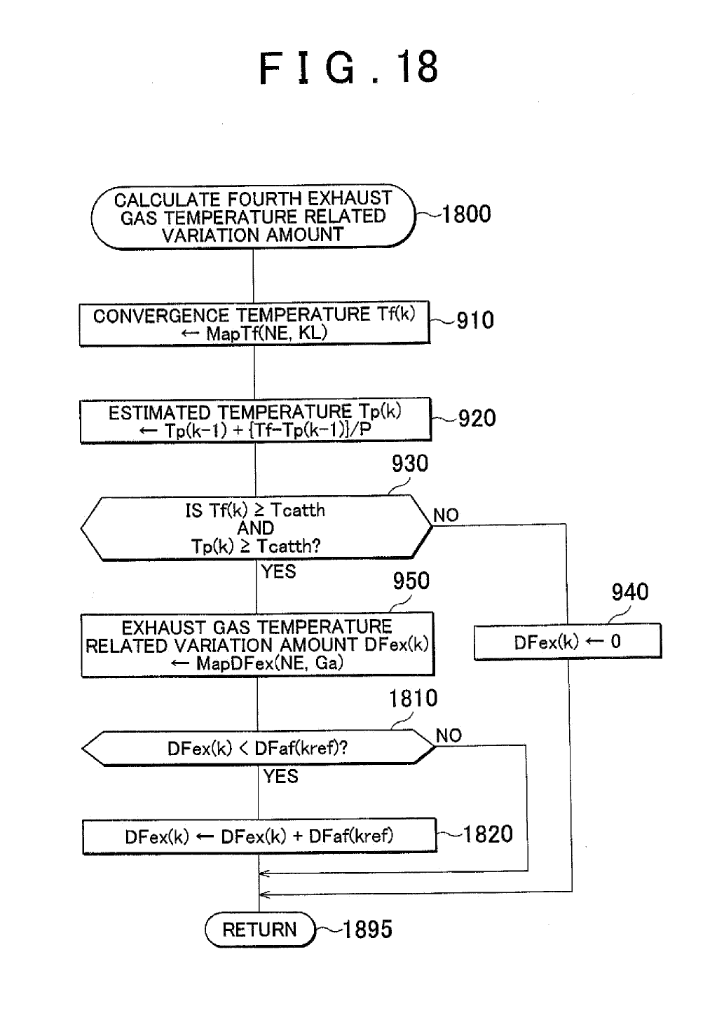

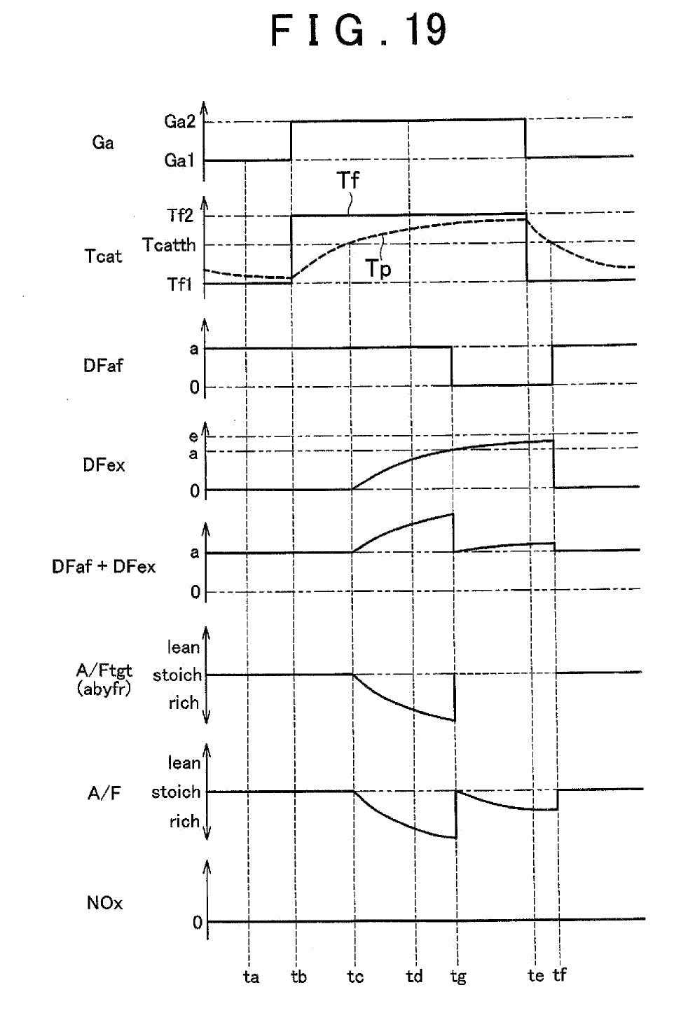

Hereinafter, the actual operations of the fourth device will be described. In the fourth device, the CPU 81 repeatedly executes the routines shown in FIG. 8 for control over fuel injection, FIG. 18 for calculation of the exhaust gas temperature related variation amount, FIG. 16 for calculation of the main feedback amount and FIG. 11 for calculation of the sub-feedback amount at each predetermined timing.

The fourth device differs from the first device only in that the CPU 81 executes the flow chart shown in “FIG. 18” and the flow chart shown in “FIG. 16” instead of the flow chart shown in FIG. 9 and the flow chart shown in FIG. 10. Then, hereinafter, the routines executed by the CPU 81 will be described focusing on the difference. Note that FIG. 16 has been already described as the main feedback amount calculation routine in the third device.

The CPU 81 repeatedly executes “fourth exhaust gas temperature related variation amount calculation routine” shown by the flow chart in FIG. 18 at each timing at which the crank angle of the fuel injection cylinder coincides with the crank angle θf. Through this routine, the CPU 81 calculates the exhaust gas temperature related variation amount DFex.

The routine shown in FIG. 18 differs from the routine shown in FIG. 9 only in that step 1810 and step 1820 are added. Then, like reference signs to those assigned to the steps of FIG. 9 denote steps in FIG. 18 for executing the same processes as those of the steps of FIG. 9. The detailed description of these steps is omitted where appropriate.

Specifically, as the CPU 81 starts processing from step 1800 of FIG. 18 at the above timing, the CPU 81 causes the process to proceed to step 930 via step 910 and step 920. Then, when both the convergence temperature Tf(k) and the current temperature Tp(k) are higher than or equal to the threshold temperature Tcatth, the CPU 81 causes the process to proceed to step 950 and then calculates the exhaust gas temperature related variation amount DFex(k).

Subsequently, the CPU 81 causes the process to proceed to step 1810. In step 1810, the CPU 81 determines whether the exhaust gas temperature related variation amount DFex(k) at the present time point is smaller than the main feedback amount DFaf(kref) at the reference time point kref. Note that, as described above, the CPU 81 stores the time point at which the result of determination in step 930 varies from “negative determination” to “affirmative determination” (time k) in the RAM 83 as the reference time point kref.

When the exhaust gas temperature related variation amount DFex(k) at the present time point is “larger than or equal to” the main feedback amount DFaf(kref) at the reference time point kref, the CPU 81 makes “negative determination” in step 1810, causes the process to proceed to step 1895 and then once ends the routine. Thus, in this case, the basic fuel injection amount Fbase(k) is corrected using the exhaust gas temperature related variation amount DFex(k) calculated in step 950 (see step 850 of FIG. 8).

In contrast to this, when the exhaust gas temperature related variation amount DFex(k) at the present time point is “smaller” than the main feedback amount DFaf(kref) at the reference time point kref, the CPU 81 makes “affirmative determination” in step 1810 and then causes the process to proceed to step 1820. In step 1820, the CPU 81 stores the “sum of the exhaust gas temperature related variation amount DFex(k) and the air-fuel ratio related variation amount DFaf(kref) at the reference time point kref” as the exhaust gas temperature related variation amount DFex(k). After that, the CPU 81 causes the process to proceed to step 1895 and then once ends the routine. Thus, in this case, the exhaust gas temperature related variation amount DFex(k) is changed to the above “sum”, and the basic fuel injection amount Fbase is corrected using the “sum” (see step 850 of FIG. 8).

As described above, when exhaust gas temperature control is executed, the fourth device stops air-fuel ratio control and, where necessary, corrects the exhaust gas temperature related variation amount DFex to the “sum of the exhaust gas temperature related variation amount DFex and the air-fuel ratio related variation amount DFaf at the reference time point kref”. As a result, even when air-fuel ratio control is stopped when exhaust gas temperature control is executed, the final fuel injection amount Fi is reliably varied (increased). Therefore, the temperature of exhaust gas is appropriately decreased, and the NOx emission is substantially kept at a value close to zero.

Note that, as is understood from the above description, irrespective of whether the air-fuel ratio related variation amount DFaf(kref) at the reference time point kref is a positive value or a negative value, the fourth device is able to set an appropriate exhaust gas temperature related variation amount DFex in accordance with the above routines. The fourth embodiment of the invention is described above.

Next, a control device according to a fifth embodiment of the invention (hereinafter, also referred to as “fifth device”) will be described.

The fifth device is applied to an engine having a similar configuration to that of the engine 10 to which the first device is applied (see FIG. 1, and, hereinafter, for the sake of convenience, referred to as “engine 10”). Then, the description of the outline of the system to which the fifth device is applied is omitted.

The outline of operations of the fifth device will be described. The fifth device differs from the first device in that, when exhaust gas temperature control is executed, the “exhaust gas temperature related variation amount DFex is varied on the basis of the temperature of the catalyst 53”.

Specifically, when exhaust gas temperature control is executed, the fifth device employs an “amount obtained by multiplying a reference variation amount DFexbase set on the basis of the operating state of the engine 10 by a correction coefficient CRex set in consideration of the temperature of the catalyst 53 (corrected variation amount)” as the exhaust gas temperature related variation amount DFex.

Furthermore, the fifth device, as well as the first device, “continues” air-fuel ratio control even when exhaust gas temperature control is executed. At this time, the fifth device employs an “air-fuel ratio set in consideration of the exhaust gas temperature related variation amount DFex” as in the case of the second device as the target upstream air-fuel ratio abyfr(k) in air-fuel ratio control.

The fifth device uses the exhaust gas temperature related variation amount DFex(k) set as described above to execute exhaust gas temperature control, and executes air-fuel ratio control in accordance with the target upstream air-fuel ratio abyfr(k) set as described above. The outline of operations of the fifth device is described above.

Hereinafter, setting the air-fuel ratio related variation amount DFaf and the exhaust gas temperature related variation amount DFex in accordance with the above described concept is also referred to as “fifth control method”.

The concept of air-fuel ratio control in the fifth device is the same as the concept of air-fuel ratio control in (not the first device but) the second device. Then, the detailed description of air-fuel ratio control in the fifth device is omitted.

The exhaust gas temperature control will be described. The fifth device initially calculates the reference variation amount DFexbase on the basis of the operating state of the engine 10. Specifically, the fifth device applies the engine rotation speed NE(k) and intake air mass Ga(k) at the present time point to a reference variation amount table MapDFexbase(NE,Ga) that presets the “correlation among an engine rotation speed NE, an intake air mass Ga and a reference variation amount DFexbase” to thereby calculate the reference variation amount DFexbase(k) at the present time point. The reference variation amount DFexbase is set as an adequate value that is larger than the air-fuel ratio related variation amount DFaf(kref) at the reference time point kref.

Subsequently, the fifth device calculates the correction coefficient CRex for correcting the reference variation amount DFexbase in accordance with the following mathematical expression (16) and mathematical expression (17). In the following mathematical expression (16), Tcatth denotes the threshold temperature Tcatth of the catalyst 53.

### Where Tp<Tf:

CRex(k)={Tp(k)−Tcatth}/{Tf(k)−Tcatth} (16)

### Where Tp≧Tf:

CRex(k)=1 (17)

Subsequently, the fifth device calculates the exhaust gas temperature related variation amount DFex(k) in accordance with the following mathematical expression (18).

DFex(k)=DFexbase(k)×CRex(k) (18)

As is understood from the above described mathematical expression (16), the correction coefficient CRex calculated from the mathematical expression is smaller than or equal to 1, and approaches 1 as the current temperature Tp approaches the convergence temperature Tf. Thus, the exhaust gas temperature related variation amount DFex obtained by multiplying the reference variation amount DFexbase by the correction coefficient CRex increases as the current temperature Tp approaches the convergence temperature Tf. Thus, as the current temperature Tp approaches the convergence temperature Tf (that is, as the current temperature Tp increases toward the convergence temperature Tf), the exhaust gas temperature related variation amount DFex increases (that is, the temperature of exhaust gas is more decreased).

Furthermore, as is understood from the above described mathematical expression (17), when the current temperature Tp is higher than or equal to the convergence temperature Tf (that is, when the current temperature Tp decreases toward the convergence temperature Tf), the correction coefficient CRex is kept at 1. By so doing, in this case, the exhaust gas temperature related variation amount DFex is kept at the reference variation amount DFexbase. The exhaust gas temperature control executed by the fifth device is described above.

An example of control using the fifth control method will be described. The fifth device executes the above described air-fuel ratio control and exhaust gas temperature control in accordance with the above described “fifth control method”. Hereinafter, an example of a mode in which (both of or one of) air-fuel ratio control and exhaust gas temperature control is executed will be described with reference to FIG. 19. FIG. 19 is a time chart that shows an example in the case where the fifth device “executes” control according to the fifth control method. In FIG. 19, for the sake of easy understanding, schematic waveforms of the actual waveforms of values are shown. Note that FIG. 19 is a time chart on the assumption that the air-fuel ratio related variation amount DFaf at the time when air-fuel ratio control is being executed is a positive value.

At time ta in the time chart shown in FIG. 19, only air-fuel ratio control is being executed. At time ta, as in the case of the above, the intake air mass Ga is the value Ga1, and both the convergence temperature Tf and the current temperature Tp are lower than the threshold temperature Tcatth. Furthermore, at time ta, the target air-fuel ratio A/Ftgt is set at the stoichiometric air-fuel ratio stoich, and the air-fuel ratio related variation amount DFaf is the value a. In addition, the exhaust gas temperature related variation amount DFex is zero. Thus, the total DFaf+DFex is the value a. Thus, the actual air-fuel ratio A/F coincides with the target air-fuel ratio (stoichiometric air-fuel ratio stoich). As a result, the NOx emission is close to zero.

After that, the intake air mass Ga increases from the value Ga1 to the value Ga2 at time tb, and both the convergence temperature Tf and the current temperature Tp are higher than or equal to the threshold temperature Tcatth at time tc. At this time, air-fuel ratio control is “continued”, and exhaust gas temperature control is started.

Specifically, initially, in association with exhaust gas temperature control, at time tc, the reference variation amount DFexbase (in the present embodiment, a value e) is set. Here, the current temperature Tp at time tc is lower than the convergence temperature Tf, so the correction coefficient CRex is set in accordance with the above described mathematical expression (16). Then, the reference variation amount DFexbase is multiplied by the correction coefficient CRex to thereby calculate the exhaust gas temperature related variation amount DFex. Specifically, the current temperature Tp at time tc coincides with the threshold temperature Tcatth, so the correction coefficient CRex is zero. Thus, the exhaust gas temperature related variation amount DFex at time tc is zero.

After that, the current temperature Tp increases toward the convergence temperature Tf with time, so the correction coefficient CRex increases toward 1. Thus, the exhaust gas temperature related variation amount DFex increases with time. In this way, during the period when the exhaust gas temperature related variation amount DFex increases (from time tc to time tg (described later)), as in the case of the above “example of control according to the second control method”, the air-fuel ratio related variation amount DFaf is kept at a value at the time point before time tc (value a). Therefore, at or after time tc, the total DFaf+DFex gradually increases from the value a, and the actual air-fuel ratio A/F gradually decreases from the stoichiometric air-fuel ratio stoich (becomes richer).

As a result, in the period from time tc to time tg (described later), the temperature of exhaust gas is appropriately decreased, and the NOx emission is substantially kept at a value close to zero.

After that, at time tg, the exhaust gas temperature related variation amount DFex reaches the air-fuel ratio related variation amount DFaf (value a) at the reference time point kref (in the present embodiment, time ta, time tb or time tc). At this time, as described in the above “second control method”, air-fuel ratio control is “stopped”. Therefore, at time tg, the air-fuel ratio related variation amount DFaf reduces from the value a to zero. Thus, at time tg, the total DFaf+DFex reduces to the value a (which corresponds to the exhaust gas temperature related variation amount DFex), and the actual air-fuel ratio A/F increases to the stoichiometric air-fuel ratio stoich.

After that, as in the case of the above, the exhaust gas temperature related variation amount DFex increases with time. Therefore, in the period from time tg to time tf (described later), the total DFaf+DFex gradually increases from the value a, and the actual air-fuel ratio A/F gradually reduces from the stoichiometric air-fuel ratio stoich.

As a result, in the period from time tg to time tf (described later) as well, the temperature of exhaust gas may be appropriately decreased, and the NOx emission is substantially kept at a value close to zero.

After that, as in the case of the above, the intake air mass Ga reduces from the value Ga2 to the value Ga1 at time te, and both the convergence temperature Tf and the current temperature Tp are lower than the threshold temperature Tcatth at time tf. At this time, exhaust gas temperature control is ended, and air-fuel ratio control (the target air-fuel ratio A/Ftgt is the stoichiometric air-fuel ratio stoich) is resumed. An example of control according to the fifth control method is described above.

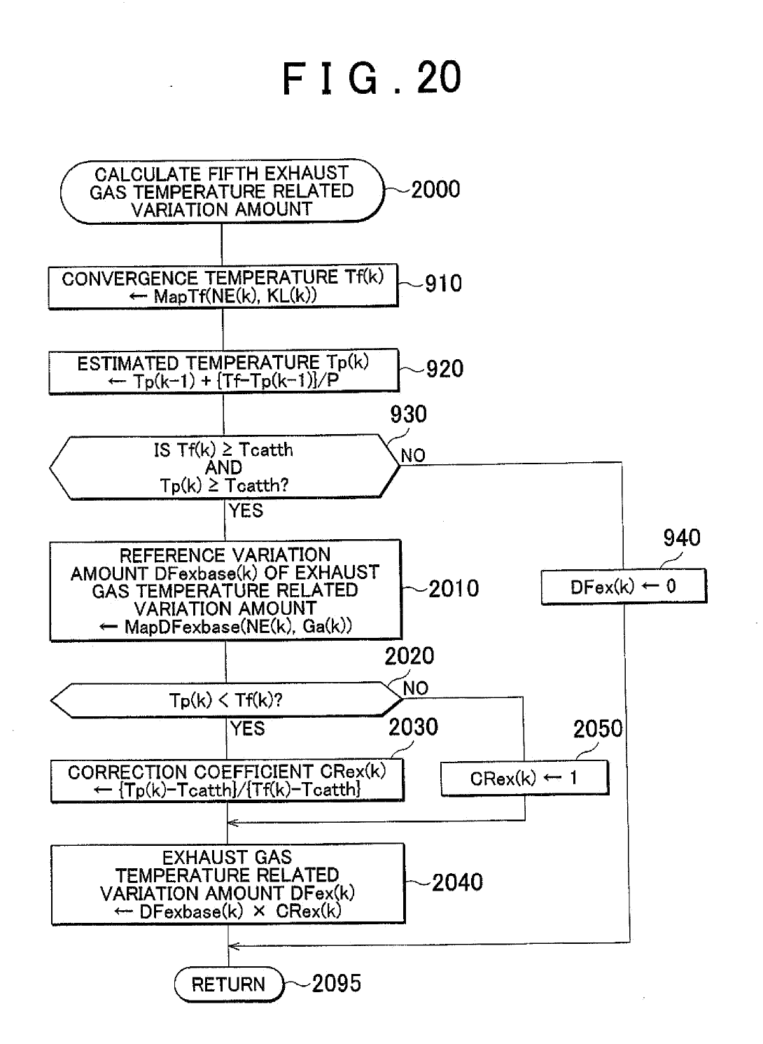

Hereinafter, the actual operations of the fifth device will be described. In the fifth device, the CPU 81 repeatedly executes the routines shown in FIG. 13 for control over fuel injection, FIG. 20 for calculation of the exhaust gas temperature related variation amount, FIG. 10 for calculation of the main feedback amount and FIG. 11 for calculation of the sub-feedback amount at each predetermined timing.

The fifth device differs from the first device only in that the CPU 81 executes the flow chart shown in “FIG. 20” instead of the flow chart shown in FIG. 9. Then, hereinafter, the routines executed by the CPU 81 will be described focusing on the difference. Note that FIG. 13 has been already described as the fuel injection control routine in the second device.

The CPU 81 repeatedly executes “fifth exhaust gas temperature related variation amount calculation routine” shown by the flow chart in FIG. 20 at each timing at which the crank angle of the fuel injection cylinder coincides with the crank angle θf. Through this routine, the CPU 81 calculates the reference variation amount DFexbase of the exhaust gas temperature related variation amount, and multiplies the reference variation amount DFexbase by the correction coefficient CRex to thereby calculate the exhaust gas temperature related variation amount DFex.

The routine shown in FIG. 20 differs from the routine shown in FIG. 9 in that step 950 is omitted and step 2010 to step 2050 are added. Then, like reference signs to those assigned to the steps of FIG. 9 denote steps in FIG. 20 for executing the same processes as those of the steps of FIG. 9. The detailed description of these steps is omitted where appropriate.

Specifically, as the CPU 81 starts processing from step 2000 of FIG. 20 at the above timing, the CPU 81 causes the process to proceed to step 930 via step 910 and step 920. Then, when both the convergence temperature Tf(k) and the current temperature Tp(k) are higher than or equal to the threshold temperature Tcatth, the CPU 81 makes “affirmative determination” in step 930 and then causes the process to proceed to step 2010.

In step 2010, the CPU 81 applies the engine rotation speed NE(k) and intake air mass Ga(k) at the present time point to the above descried reference variation amount table MapDFexbase(NE,Ga) to thereby calculate the reference variation amount DFexbase(k) at the present time point.

Subsequently, the CPU 81 causes the process to proceed to step 2020. In step 2020, the CPU 81 determines whether the current temperature Tp(k) is lower than the convergence temperature Tf(k). When the current temperature Tp(k) is smaller than the convergence temperature Tf(k), the CPU 81 makes “affirmative determination” in step 2020 and then causes the process to proceed to step 2030.

In step 2030, the CPU 81 calculates the correction coefficient CRex(k) on the basis of the current temperature Tp(k), the convergence temperature Tf(k) and the threshold temperature Tcatth in accordance with the above described mathematical expression (16).

Subsequently, the CPU 81 causes the process to proceed to step 2040. In step 2040, the CPU 81 multiplies the reference variation amount DFexbase(k) by the correction coefficient CRex(k) in accordance with the above described mathematical expression (18) to thereby calculate the exhaust gas temperature related variation amount DFex(k). After that, the CPU 81 causes the process to proceed to step 2095 and then once ends the routine.

On the other hand, when the current temperature Tp(k) at the present time point is higher than or equal to the convergence temperature Tf(k), the CPU 81 makes “negative determination” in step 2020 and then causes the process to proceed to step 2050. In step 2050, the CPU 81 stores “1” as the correction coefficient CRex(k).

After that, the CPU 81 causes the process to proceed to step 2040 as in the case of the above, and then calculates the exhaust gas temperature related variation amount DFex(k). In this case, because the correction coefficient CRex(k) is 1, the exhaust gas temperature related variation amount DFex(k) is equal to the reference variation amount DFexbase(k). That is, in this case, the reference variation amount DFexbase(k) is not corrected.

Furthermore, the CPU 81 repeatedly executes the routine of FIG. 13 at each predetermined timing as in the case of the second device. By so doing, the target upstream air-fuel ratio abyfr(k) is corrected on the basis of the exhaust gas temperature related variation amount DFex(k) calculated as described above (see step 1310 and step 1320 in FIG. 13). Then, the basic fuel injection amount Fbase(k) is corrected using the main feedback amount DFaf(k), set on the basis of the corrected target upstream air-fuel ratio abyfr(k), and the exhaust gas temperature related variation amount DFex(k) to thereby calculate the final fuel injection amount Fi(k) (see step 850 of FIG. 13).

As described above, the fifth device varies the exhaust gas temperature related variation amount DFex on the basis of the temperature of the catalyst 53. As a result, the temperature of exhaust gas is appropriately decreased. Furthermore, the fifth device corrects the target upstream air-fuel ratio abyfr on the basis of the exhaust gas temperature related variation amount DFex. As a result, even when exhaust gas temperature control and air-fuel ratio control are executed in parallel with each other, the final fuel injection amount Fi is reliably varied (increased) by the exhaust gas temperature related variation amount DFex. By so doing, the temperature of exhaust gas is appropriately decreased, and the NOx emission is substantially kept at a value close to zero.

Note that, in the fifth device, the concept of the above described exhaust gas temperature control (see the routine of FIG. 20) is applied to the control method used in the second device. Instead, the concept of the exhaust gas temperature control of the fifth device may be applied to any one of the first device, the third device and the fourth device.

Note that, as is understood from the above description, irrespective of whether the air-fuel ratio related variation amount DFaf(kref) at the reference time point kref is a positive value or a negative value, the fifth device is able to set an appropriate air-fuel ratio related variation amount DFaf and an appropriate exhaust gas temperature related variation amount DFex in accordance with the above routines. The fifth embodiment of the invention is described above.

Incidentally, the control devices (the first device to the fifth device) according to the above described embodiments are configured to execute exhaust gas temperature control when “both” the convergence temperature Tf and current temperature Tp of the catalyst 53 are higher than or equal to the threshold temperature Tcatth (for example, see step 930 of FIG. 9). However, the control device according to the aspect of the invention may be configured to execute exhaust gas temperature control when “at least one” of the convergence temperature Tf and the current temperature Tp is higher than or equal to the threshold temperature Tcatth. That is, the control device according to the aspect of the invention may be configured to execute exhaust gas temperature control when it is determined that the temperature of the catalyst may excessively increase.

As described above, the control devices (the first device to the fifth device) according to the embodiments of the invention are applied to the internal combustion engine 10 equipped with the catalyst 53.

The first device according to the aspect of the invention includes: an air-fuel ratio control unit that executes control over the air-fuel ratio of air-fuel mixture supplied to the internal combustion engine 10 and that varies the amount of fuel supplied to the internal combustion engine 10 in accordance with a first variation amount DFaf set so as to bring the air-fuel ratio into coincidence with the target air-fuel ratio abyfr (step 850 of FIG. 8, and the routines of FIG. 10 and FIG. 11); and an exhaust gas temperature control unit that executes control over the temperature of the exhaust gas and that varies the amount of fuel supplied to the internal combustion engine 10 in accordance with a second variation amount DFex set so as to decrease the temperature of the exhaust gas (step 850 of FIG. 8, and the routine of FIG. 9).

In the first device, when control over the air-fuel ratio is being executed at a first time point (for example, time ta, time tb or time tc of FIG. 7) and at least control over the temperature of the exhaust gas between control over the air-fuel ratio and control over the temperature of the exhaust gas is executed during a catalyst temperature control period that is a period from the first time point or a second time point after the first time point (for example, time tc of FIG. 7) to a third time point after the second time point (for example, time tf of FIG. 7), the first variation amount DFaf and the second variation amount DFex at a fourth time point in the catalyst temperature control period (for example, time td of FIG. 7) are set such that the total of the first variation amount DFaf and the second variation amount DFex is larger than or equal to the first variation amount DFaf at the first time point.

Furthermore, in the first device, the catalyst temperature control period is a period during which it is determined during the catalyst temperature control period that at least one of the current temperature Tp of the catalyst 53, which is the temperature of the catalyst 53 at the present time point, and the convergence temperature Tf of the catalyst 53, which is an estimated temperature that the temperature of the catalyst 53 reaches at a future time point, is higher than or equal to the threshold temperature Tcatth (period during which “affirmative determination” is made in step 920 of FIG. 9).

Furthermore, in the first device, the first variation amount DFaf is a variation amount with reference to a basic amount Fbase that is the amount of fuel set on the basis of the target air-fuel ratio abyfr, and the second variation amount DFex is a variation amount with reference to the basic amount Fbase (see step 850 of FIG. 8).

Furthermore, in the first device, when the second variation amount DFex set at the fourth time point is smaller than the first variation amount DFaf at the first time point (when “affirmative determination” is made in step 1050 of FIG. 10), both control over the air-fuel ratio and control over the temperature of the exhaust gas are executed at the fourth time point.

Furthermore, in the first device, the target air-fuel ratio abyfr at the fourth time point is set at an air-fuel ratio smaller than the target air-fuel ratio abyfr at the first time point (see step 890 of FIG. 8).

Subsequently, in the second device, the target air-fuel ratio abyfr at the fourth time point is an air-fuel ratio obtained by dividing the target air-fuel ratio abyfr at the first time point by a value DFexcon (see step 1310 of FIG. 13) that is obtained by dividing the sum of the second variation amount DFex and the basic amount Fbase at the fourth time point by the basic amount Fbase (see step 1320).

Subsequently, in the third device, when the second variation amount DFex set at the fourth time point is smaller than the first variation amount DFaf at the first time point (when “affirmative determination” is made in step 1510 of FIG. 15), the second variation amount DFex is corrected to an amount DFexlarge larger than or equal to the first variation amount DFaf and then only control over the temperature of the exhaust gas between control over the air-fuel ratio and control over the temperature of the exhaust gas is executed at the fourth time point.

Subsequently, in the fourth device, when the second variation amount DFex that is set at the fourth time point is smaller than the first variation amount DFaf at the first time point (when “affirmative determination” is made in step 1810 of FIG. 18), the second variation amount DFex is corrected to the sum of the second variation amount DFex and the first variation amount DFaf (see step 1820) and then only control over the temperature of exhaust gas between control over the air-fuel ratio and control over the temperature of exhaust gas is executed at the fourth time point.

Subsequently, in the fifth device, a corrected variation amount obtained by multiplying a reference variation amount DFexbase, which is set on the basis of the operating state of the internal combustion engine 10 and which is larger than the first variation amount DFaf at the first time point, by a correction coefficient CRex, which approaches 1 as the current temperature Tp of the catalyst 53 approaches the convergence temperature Tf of the catalyst 53, is employed as the second variation amount DFex (see step 2030 of FIG. 20).

Furthermore, in the fifth device, a value DFexcon obtained by dividing the difference between the current temperature Tp of the catalyst 53 and the threshold temperature Tcatth by the difference between the convergence temperature Tf of the catalyst 53 and the threshold temperature Tcatth is employed as the correction coefficient CRex (see step 2020 of FIG. 20).

Incidentally, in the first device to the fifth device, the stoichiometric air-fuel ratio stoich is employed as the target air-fuel ratio abyfr at the first time point (for example, see step 810 of FIG. 8).

Furthermore, in the first device to the fifth device, the catalyst 53 may be a catalyst having such a characteristic that the catalytic conversion efficiency of nitrogen oxides NOx contained in the exhaust gas by the catalyst 53 decreases at a first decreasing rate in the case where the oxygen concentration of the exhaust gas deviates from a reference oxygen concentration that is the oxygen concentration of the exhaust gas that arises at the time when the air-fuel ratio of air-fuel mixture is the stoichiometric air-fuel ratio stoich, in a direction in which the oxygen concentration increases and the catalytic conversion efficiency of nitrogen oxides NOx decreases at a second decreasing rate smaller than the first decreasing rate in the case where the oxygen concentration of the exhaust gas deviates from the reference oxygen concentration in a direction in which the oxygen concentration reduces.

The aspect of the invention is not limited to the above described embodiments; it may be modified into various alternative embodiments within the scope of the invention. Alternative embodiments will be described below.

For example, the control devices according to the above described embodiments employ the stoichiometric air-fuel ratio stoich as the target upstream air-fuel ratio abyfr. However, the control device according to the aspect of the invention may be configured to employ an air-fuel ratio, other than the stoichiometric air-fuel ratio stoich, as the target upstream air-fuel ratio abyfr. That is, the control device according to the aspect of the invention just needs to set the target upstream air-fuel ratio abyfr at an adequate value in consideration of the exhaust gas conversion performance of the catalyst.

Furthermore, the control devices according to the above described embodiments estimate the current temperature Tp of the catalyst 53 on the basis of the convergence temperature Tf (for example, see step 920 of FIG. 9). However, the control device according to the aspect of the invention may be configured to acquire the current temperature of the catalyst by a sensor that is able to measure the temperature of the catalyst.

Furthermore, the control devices according to the above described embodiments include only one-type injectors. Instead, the control device according to the aspect of the invention may include multiple-type injectors. For example, the engine 10 may include injectors for air-fuel ratio control and an injector for exhaust gas temperature control. That is, the internal combustion engine to which the control device according to the aspect of the invention is applied just needs to be configured to vary the final amount of fuel supplied to the internal combustion engine (that is, introduced into the combustion chambers).

Furthermore, the control devices according to the above described embodiments are applied to the engine equipped with the three-way catalyst (spark ignition engine). Instead, the control device according to the aspect of the invention may also be applied to an engine equipped with a NOx storage reduction catalyst (for example, diesel engine). Furthermore, the control devices according to the above described embodiments include only one catalyst. Instead, the control device according to the aspect of the invention may be applied to an engine equipped with a plurality of catalysts.

Incidentally, in the control devices according to the above described embodiments, in consideration of the fuel cooling effect and the NOx emission, when exhaust gas temperature control is executed, the air-fuel ratio related variation amount DFaf and the exhaust gas temperature related variation amount DFex are set such that the air-fuel ratio of catalyst introduction gas is constantly smaller (richer) than or equal to the stoichiometric air-fuel ratio stoich. However, focusing on the NOx emission, there is a case where the air-fuel ratio of catalyst introduction gas is allowed to be larger (leaner) than the stoichiometric air-fuel ratio stoich.

Specifically, in the case where the catalyst 53 has an oxygen storage ability (characteristic that oxygen in catalyst introduction gas is stored when the air-fuel ratio of the gas is a lean air-fuel ratio and oxygen is released into catalyst introduction gas when the air-fuel ratio of the gas is a rich air-fuel ratio), it is presumable that, when the catalyst 53 has a sufficient capacity to be able to store oxygen, even when the air-fuel ratio of catalyst introduction gas is a lean air-fuel ratio, the NOx emission does not increase during a period when the catalyst 53 is able to store oxygen.

Then, the following control device may be, for example, employed as a control device applied to an internal combustion engine equipped with a catalyst having such a characteristic. A control device, which is applied to an internal combustion engine equipped with a catalyst that purifies exhaust gas of the internal combustion engine and that has such a characteristic that oxygen in catalyst introduction gas, which is exhaust gas introduced into the catalyst, is stored in the catalyst when the oxygen concentration of the catalyst introduction gas is larger than a reference oxygen concentration that is the oxygen concentration of gas that arises when air and fuel burn at a stoichiometric air-fuel ratio and oxygen stored in the catalyst is released into the catalyst introduction gas when the oxygen concentration of the catalyst introduction gas is smaller than the reference oxygen concentration to thereby bring the oxygen concentration of the exhaust gas in the catalyst close to the reference oxygen concentration, includes: an air-fuel ratio control unit that executes control over the air-fuel ratio of air-fuel mixture supplied to the internal combustion engine and that varies the amount of fuel supplied to the internal combustion engine in accordance with a first variation amount that is set so as to bring the air-fuel ratio into coincidence with a target air-fuel ratio; and an exhaust gas temperature control unit that executes control over the temperature of the exhaust gas and that varies the amount of fuel supplied to the internal combustion engine in accordance with a second variation amount that is set so as to decrease the temperature of the exhaust gas, wherein, in the case where control over the air-fuel ratio is being executed at a first time point and at least control over the temperature of the exhaust gas between control over the air-fuel ratio and control over the temperature of the exhaust gas is executed during a catalyst temperature control period that is a period from the first time point or a second time point after the first time point to a third time point after the second time point, when the second variation amount that is set at a fourth time point in the catalyst temperature control period is smaller than the first variation amount at the first time point, a reference variation amount that is set on the basis of the operating state of the internal combustion engine and that is larger than the first variation amount at the first time point is employed as the second variation amount when the oxygen concentration of catalyst emission gas that is exhaust gas emitted from the catalyst at the fourth time point is higher than the reference oxygen concentration, and a corrected variation amount obtained by multiplying a reference variation amount by a correction coefficient that approaches 1 as the temperature of the catalyst approaches a convergence temperature of the catalyst is employed as the second variation amount when the oxygen concentration of the catalyst emission gas at the fourth time point is lower than or equal to the reference oxygen concentration.

With the above control device, when the oxygen concentration of catalyst emission gas is lower than or equal to the reference oxygen concentration (when the air-fuel ratio of catalyst emission gas is a stoichiometric air-fuel ratio or a rich air-fuel ratio), the “corrected variation amount” is employed as the second variation amount. When the corrected variation amount is employed, there is a case where the total of the first variation amount and the second variation amount during the catalyst temperature control period (fourth time point) is not larger than or equal to the first variation amount before the catalyst temperature control period (first time point). That is, there is a case where the air-fuel ratio of catalyst introduction gas is a lean air-fuel ratio. However, it is presumable that, when the air-fuel ratio of catalyst emission gas is a “stoichiometric air-fuel ratio or rich air-fuel ratio”, the catalyst has a sufficient capacity to be able to store oxygen, so it is presumable that, even when the air-fuel ratio of catalyst introduction gas is a lean air-fuel ratio, the NOx emission does not increase during a period when the catalyst is able to store oxygen.

By so doing, the control device is able to appropriately execute both control over the temperature of the exhaust gas and control over the air-fuel ratio (among others, control over the air-fuel ratio) during the catalyst temperature control period.

While the invention has been described with reference to example embodiments thereof, it is to be understood that the invention is not limited to the described example embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A control device that is applied to an internal combustion engine equipped with a catalyst that purifies exhaust gas of the internal combustion engine, comprising:
an air-fuel ratio control unit that executes control over an air-fuel ratio of air-fuel mixture supplied to the internal combustion engine and that varies an amount of fuel supplied to the internal combustion engine in accordance with a first variation amount that is set so as to bring the air-fuel ratio into coincidence with a target air-fuel ratio; and
an exhaust gas temperature control unit that executes control over a temperature of the exhaust gas and that varies an amount of fuel supplied to the internal combustion engine in accordance with a second variation amount that is set so as to decrease the temperature of the exhaust gas, wherein
when control over the air-fuel ratio is being executed at a first time point and at least control over the temperature of the exhaust gas between control over the air-fuel ratio and control over the temperature of the exhaust gas is executed during a catalyst temperature control period that is a period from the first time point or a second time point after the first time point to a third time point after the second time point, the first variation amount and the second variation amount at a fourth time point in the catalyst temperature control period are set such that the total of the first variation amount and the second variation amount at the fourth time point is larger than or equal to the first variation amount at the first time point.

2. The control device according to claim 1, wherein
the catalyst temperature control period is a period during which it is determined during the catalyst temperature control period that at least one of a current temperature of the catalyst, which is a temperature of the catalyst at a present time point, and a convergence temperature of the catalyst, which is an estimated temperature that the temperature of the catalyst reaches at a future time point, is higher than or equal to a threshold temperature.

3. The control device according to claim 1, wherein
the first variation amount is a variation amount with reference to a basic amount that is the amount of fuel set on the basis of the target air-fuel ratio, and the second variation amount is a variation amount with reference to the basic amount.

4. The control device according to claim 1, wherein
when the second variation amount that is set at the fourth time point is smaller than the first variation amount at the first time point, both control over the air-fuel ratio and control over the temperature of the exhaust gas are executed at the fourth time point.

5. The control device according to claim 4, wherein
the target air-fuel ratio at the fourth time point is smaller than the target air-fuel ratio at the first time point.

6. The control device according to claim 5, wherein
the target air-fuel ratio at the fourth time point is an air-fuel ratio obtained by dividing the target air-fuel ratio at the first time point by a value obtained by dividing the sum of the second variation amount at the fourth time point and the basic amount by the basic amount.

7. The control device according to claim 1, wherein
when the second variation amount that is set at the fourth time point is smaller than the first variation amount at the first time point, the second variation amount is corrected to an amount larger than or equal to the first variation amount and then only control over the temperature of the exhaust gas between control over the air-fuel ratio and control over the temperature of the exhaust gas is executed at the fourth time point.

8. The control device according to claim 1, wherein
when the second variation amount that is set at the fourth time point is smaller than the first variation amount at the first time point, the second variation amount is corrected to the sum of the second variation amount and the first variation amount and then only control over the temperature of the exhaust gas between control over the air-fuel ratio and control over the temperature of the exhaust gas is executed at the fourth time point.

9. The control device according to claim 1, wherein
the second variation amount is a corrected variation amount that is set on the basis of an operating state of the internal combustion engine and that is obtained by multiplying a reference variation amount, which is larger than the first variation amount at the first time point, by a correction coefficient that approaches 1 as a current temperature of the catalyst approaches a convergence temperature of the catalyst.

10. The control device according to claim 9, wherein
the correction coefficient is a value obtained by dividing a difference between the current temperature of the catalyst and a threshold temperature by a difference between the convergence temperature of the catalyst and the threshold temperature.

11. The control device according to claim 1, wherein
the target air-fuel ratio at the first time point is a stoichiometric air-fuel ratio.

12. The control device according to claim 1, wherein
the catalyst has such a characteristic that a catalytic conversion efficiency of nitrogen oxides contained in the exhaust gas by the catalyst decreases at a first decreasing rate in the case where an oxygen concentration of the exhaust gas deviates from a reference oxygen concentration that is the oxygen concentration of the exhaust gas, which occurs at the time when the air-fuel ratio of the air-fuel mixture is a stoichiometric air-fuel ratio, in a direction in which the oxygen concentration increases and the catalytic conversion efficiency of the nitrogen oxides decreases at a second decreasing rate smaller than the first decreasing rate in the case where the oxygen concentration of the exhaust gas deviates from the reference oxygen concentration in a direction in which the oxygen concentration reduces.

13. A control device that is applied to an internal combustion engine equipped with a catalyst that purifies exhaust gas of the internal combustion engine and that has such a characteristic that oxygen in catalyst introduction gas, which is exhaust gas introduced into the catalyst, is stored in the catalyst when an oxygen concentration of the catalyst introduction gas is larger than a reference oxygen concentration that is the oxygen concentration of gas that arises when air and fuel burn at a stoichiometric air-fuel ratio and oxygen stored in the catalyst is released into the catalyst introduction gas when the oxygen concentration of the catalyst introduction gas is smaller than the reference oxygen concentration to thereby bring the oxygen concentration of the exhaust gas in the catalyst close to the reference oxygen concentration, comprising:
an air-fuel ratio control unit that executes control over an air-fuel ratio of air-fuel mixture supplied to the internal combustion engine and that varies an amount of fuel supplied to the internal combustion engine in accordance with a first variation amount that is set so as to bring the air-fuel ratio into coincidence with a target air-fuel ratio; and
an exhaust gas temperature control unit that executes control over a temperature of the exhaust gas and that varies an amount of fuel supplied to the internal combustion engine in accordance with a second variation amount that is set so as to decrease the temperature of the exhaust gas, wherein
in the case where control over the air-fuel ratio is being executed at a first time point and at least control over the temperature of the exhaust gas between control over the air-fuel ratio and control over the temperature of the exhaust gas is executed during a catalyst temperature control period that is a period from the first time point or a second time point after the first time point to a third time point after the second time point, when the second variation amount that is set at a fourth time point in the catalyst temperature control period is smaller than the first variation amount at the first time point, a reference variation amount that is set on the basis of an operating state of the internal combustion engine and that is larger than the first variation amount at the first time point is employed as the second variation amount when the oxygen concentration of catalyst emission gas that is exhaust gas emitted from the catalyst at the fourth time point is higher than the reference oxygen concentration, and a corrected variation amount obtained by multiplying the reference variation amount by a correction coefficient that approaches 1 as a temperature of the catalyst approaches a convergence temperature of the catalyst is employed as the second variation amount when the oxygen concentration of the catalyst emission gas at the fourth time point is lower than or equal to the reference oxygen concentration.
